(19) United States
(12) Patent Application Publication
(10) Pub. No.: US 2022/0222686 A1
(43) Pub. Date: Jul. 14, 2022

(54) ANALYSIS APPARATUS, ANALYSIS SYSTEM, ANALYSIS METHOD AND PROGRAM

(71) Applicant: NIPPON TELEGRAPH AND TELEPHONE CORPORATION, Tokyo (JP)

(72) Inventor: Yoshiyuki MIHARA, Tokyo (JP)

(73) Assignee: NIPPON TELEGRAPH AND TELEPHONE CORPORATION, Tokyo (JP)

(21) Appl. No.: 17/610,435

(22) PCT Filed: May 21, 2019
(86) PCT No.: PCT/JP2019/020171

§ 371 Date: Nov. 10, 2021

(51) Int. Cl. G06Q 30/02

(52) U.S. Cl. CPC G06Q 30/0201

(57) ABSTRACT

An analysis device includes a memory, and a processor configured to analyze whether a first analyzer, according to a flow defined as a scenario in advance, between analysis target data and comparison target data, the analysis target data takes a peculiar value in comparison with the comparison target data for a combination of one or more attributes defined for the flow in analysis order defined for the flow. The processor is configured to cause, in response to an analysis of the peculiar value being taken by the first analyzer, according to an attribute analyzed to take the peculiar value, a name of the attribute and character strings indicating a cause of occurrence of the peculiar value in the attribute to be character strings included in a report in which results of the analyses are displayed. The character strings are defined in advance for each of the analyses in the analysis order defined for the flow.

### TECHNICAL FIELD

The present invention relates to an analysis apparatus, an analysis system, an analysis method and a program.

### BACKGROUND ART

As a technique for acquiring cause-and-effect relationships among events, a technique is known in which, by clustering pieces of event information that appear in news articles and then performing, for each event cluster, burst detection is performed based on the number of appearances in news, cause-and-effect relationships among events are determined (for example Non-Patent Document 1).

In the field of marketing, it is performed to, by analyzing purchase data configured with a plurality of items (for example, article name, article classifications, purchase price, purchase time, purchase place, purchase store name, purchaser's nationality, gender, age and the like) using, for example, the technique described in Non-Patent Document 1 or the like, utilize the analysis to solve business problems (for example, planning, promotion and the like of a new article).

### PRIOR ART DOCUMENT

### Non-Patent Document

Non-Patent Document 1: Hiroki Ono, Akira Utsumi, “Extracting Causal Knowledge by Time Series Analysis of Events”, Transactions of the Japanese Society for Artificial Intelligence, Volume 30 Issue 1 B (2015)

### SUMMARY OF THE INVENTION

### Problem to be Solved by the Invention

In general, purchase data is often configured with very many records. Further, many pieces of attribute information about purchasers (for example, nationality, gender, age and the like of the purchasers), many pieces of attribute information about articles (for example, article names, article classifications and the like) and the like are often included. Therefore, for example, when it is attempted to perform various kinds of analyses, such as burst detection of time-series data and determination of cause-and-effect relationships among different pieces of data, using a combination of these many attributes, the calculation cost is very high.

In comparison, by selecting only certain particular attributes from among the many attributes and performing data analysis using a combination of these particular attributes, it becomes possible to reduce the calculation cost accompanying the analysis. However, it is generally not easy to select such particular attributes. Further, even if an analysis result is obtained, it may be difficult to interpret the analysis result, or it may be difficult to utilize the analysis result to solve business problems depending on the attributes.

An embodiment of the present invention has been made in view of the above points, and an object is to implement efficient and effective data analysis.

### Means for Solving the Problem

In order to achieve the above object, an embodiment of the present invention is an analysis device for analyzing data including a plurality of attributes, the analysis device including: first analysis means for, according to a flow defined as a scenario in advance, analyzing whether, between analysis target data and comparison target data, the analysis target data takes a peculiar value in comparison with the comparison target data for a combination of one or more attributes defined for the flow in analysis order defined for the flow; and second analysis means for, if it is analyzed by the first analysis means that the peculiar value is taken, causing, according to an attribute analyzed to take the peculiar value, a name of the attribute and character strings indicating a cause of occurrence of the peculiar value in the attribute to be character strings included in a report in which results of the analyses are displayed; wherein the character strings are character strings defined in advance for each of the analyses in the analysis order defined for the flow.

### Effects of the Invention

An object is to implement efficient and effective data analysis.

### BRIEF DESCRIPTION OF DRAWINGS

FIG. 1 is a diagram showing an example of an overall configuration of a data analysis system in an embodiment of the present invention.

FIG. 2 is a diagram showing an example of purchase data.

FIG. 3 is a diagram showing an example of demographic data.

FIG. 4 is a diagram showing an example of a hardware configuration of a data analysis device in the embodiment of the present invention.

FIG. 5 is a diagram for illustrating an outline of data analysis (for each store) in the embodiment of the present invention.

FIG. 6 is a diagram for illustrating an outline of data analysis (grasp of overall trend) in the embodiment of the present invention.

FIG. 7 is a flowchart (1) showing an example of a data analysis process for each store.

FIG. 8 is a flowchart (2) showing an example of the data analysis process for each store.

FIG. 9 is a flowchart (3) showing an example of the data analysis process for each store.

FIG. 10 is a flowchart (4) showing an example of the data analysis process for each store.

FIG. 11 is a flowchart (5) showing an example of the data analysis process for each store.

FIG. 12 is a flowchart (1) showing an example of a data analysis process for understanding of overall trend.

FIG. 13 is a flowchart (2) showing an example of the data analysis process for understanding of overall trend.

FIG. 14 is a flowchart (3) showing an example of the data analysis process for understanding of overall trend.

FIG. 15 is a flowchart (4) showing an example of the data analysis process for understanding of overall trend.

FIG. 16 is a flowchart (5) showing an example of the data analysis process for understanding of overall trend.

FIG. 17A is a diagram showing an example of an analysis result report (for each store) (1/2).

FIG. 17B is a diagram showing an example of the analysis result report (for each store) (2/2).

FIG. 18A is a diagram showing an example of an analysis result report (grasp of overall trend) (1/2).

FIG. 18B is a diagram showing an example of the analysis result report (grasp of overall trend) (2/2).

FIG. 19 is a diagram showing an example of an analysis result report (correlation analysis).

### DESCRIPTION OF EMBODIMENT

An embodiment of the present invention will be described below. In the present embodiment, a data analysis system 1 which, with purchase data of each store in a certain area as a target, implements efficient and effective data analysis using a combination of attributes of the purchase data will be described. Here, in general, it is thought that, in many cases, it is not possible for a user with little analysis experience to appropriately narrow down attributes to be analysis targets to reduce calculation costs or appropriately interpret an analysis result. Therefore, by using the data analysis system 1 in the embodiment of the present embodiment, it becomes possible for especially the user with little analysis experience to efficiently and effectively perform data analysis.

Note that data to be an analysis target is not limited to purchase data. The embodiment of the present invention is applicable to any data that includes a plurality of attributes (for example, medical data, people flow data, lodging data, traffic data and the like).

In the embodiment of the present invention, a combination of attributes used for data analysis will be also referred to as “an analysis target combination”. Further, a combination (a pair) of purchase data to be an analysis target and data to be a comparison target of the purchase data will be also referred to as “a comparison target pair”. As specific examples of the analysis target combination, for example, (“nationality”, “sales”), (“nationality”, “the number of purchasers”, “sales”) and the like are given.

Note that the data to be a comparison target of purchase data (hereinafter also referred to as “comparison target data”) may be purchase data in a different period (for example, purchase data in the previous month, purchase data in the same month of the previous year, or the like of the same store), may be purchase data of a store different from the store of the purchase data (for example, purchase data of another certain store in the same month, or the like), may be data obtained by aggregating purchase data of all stores in the area (for example, data obtained by aggregating purchase data of all the stores in the area in the same month, or the like), or may be data having a certain relation with the purchase data (hereinafter also referred to as “related data”. As specific examples of the related data, for example, data indicating a statistical result of the population (the number of staying people) of the area in which the store is present, data obtained by aggregating messages and the like posted to SNS's (social network services) about a certain article, and the like are provided.

Therefore, as the comparison target pair, for example, “the latest purchase data of a user's own store and past data of the user's own store”, “the purchase data of the user's own store and purchase data of another store”, “the purchase data of the user's own store and purchase data of all the stores” and the like are considered. As for what kind of comparison target pair is to be used to perform data analysis, a user can arbitrarily set it.

Further, in the embodiment of the present invention, when there exists a difference equal to or above a predetermined difference in a certain attribute included in an analysis target combination, between analysis target purchase data and comparison target data, it is said that a peculiar point exists in this attribute. For example, when, at the time of comparing the attributes “sales” between analysis target purchase data and purchase data of the same month of the previous year for the same store, the sales of the analysis target purchase data are increasing (or decreasing) in comparison with the same month of the previous year by a predetermined value or more, it is said that a peculiar point exists in the attribute “sales”. Similarly, when, at the time of comparing the attributes “the number of purchasers” between analysis target purchase data and purchase data of the same month of another certain store, the number of purchasers of the analysis target data is increasing (or decreasing) in comparison with the other store by a predetermined value or more, it is said that a peculiar point exists in the attribute “the number of purchasers”.

Here, existence of a peculiar point may be determined by a method other than the above. For example, in a case where, as a result of performing statistical examination about a certain attribute included in an analysis target combination between analysis target purchase data and comparison target data, there is a significant difference, it may be assumed that a peculiar point exists in this attribute.

[Overall Configuration]

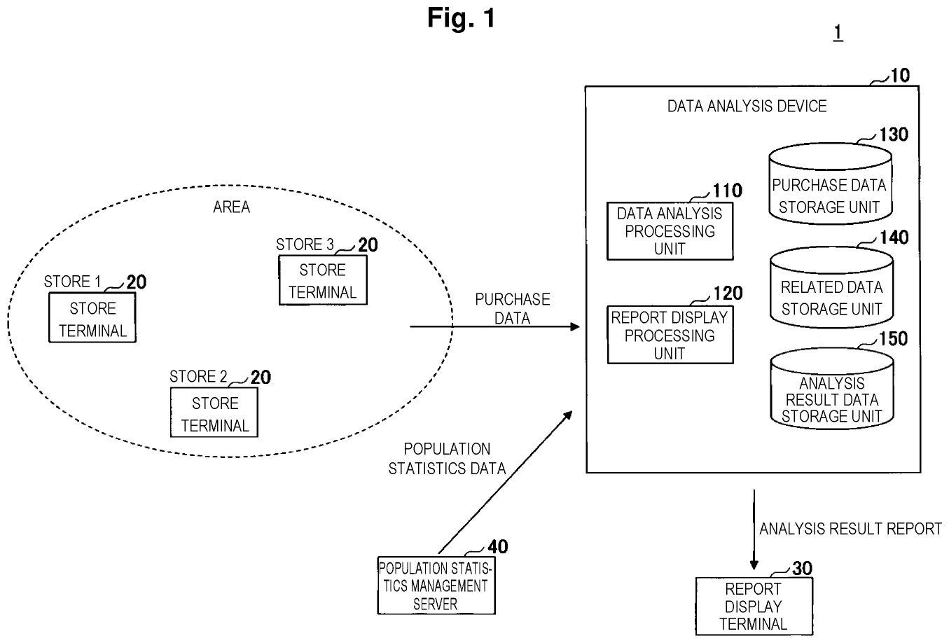

First, an overall configuration of the data analysis system 1 in the embodiment of the present invention will be described with reference to FIG. 1. FIG. 1 is a diagram showing an example of the overall configuration of the data analysis system 1 in the embodiment of the present invention.

As shown in FIG. 1, the data analysis system 1 in the embodiment of the present invention includes a data analysis device 10, a plurality of store terminals 20, one or more report display terminals 30 and one or more population statistics management servers 40.

The store terminals 20 are terminals (for example, PCs (personal computers) and the like) installed in stores and the like in the area and transmit purchase data of the stores to the data analysis device 10. In the example shown in FIG. 1, a case is shown where the store terminals 20 are installed in three stores of “Store 1”, “Store 2” and “Store 3”, respectively, in the area, and these store terminals 20 transmit purchase data to the data analysis device 10.

Here each store terminal 20 transmits, for example, purchase data obtained by performing a predetermined aggregation process (for example, purchase data obtained by monthly aggregating the number of purchasers and a total purchase amount for each article classification, or the like) to the data analysis device 10. However, such aggregation process may be performed by the data analysis device 10.

Each report display terminal 30 is a terminal (for example, a PC, a smartphone, a tablet terminal or the like) that displays a report of a data analysis result by the data analysis device 10 (an analysis result report). It becomes possible for a user of the report display terminal 30 to utilize the analysis result report to solve business problems (for example, planning promotion and the like of a new article).

Each population statistics management server 40 manages population statistics data that are an example of the related data. For example, the population statistics management server 40 returns the population statistics data in response to a request from the data analysis device 10. The population statistics data are, for example, data indicating population statistics for each time zone in a geographical area (this is also referred to as “a mesh”) determined in advance.

The data analysis device 10 is a computer or a computer system that performs data analysis of purchase data and provides the analysis result report to the report display terminal 30. At this time, the data analysis device 10 in the embodiment of the present invention performs data analysis of a comparison target pair, with an analysis target combination according to a scenario defined in advance, and provides the analysis result report that includes output character strings indicating an interpretation of a result of the data analysis. Thereby, the data analysis device 10 in the embodiment of the present invention can implement effective and efficient data analysis.

Here, the data analysis device 10 in the embodiment of the present invention has a data analysis processing unit 110 and a report display processing unit 120 as functional units. Further, the data analysis device 10 in the embodiment of the present invention has a purchase data storage unit 130, a related data storage unit 140 and an analysis result data storage unit 150 as storage units.

The purchase data storage unit 130 stores purchase data. The related data storage unit 140 stores the related data (for example, the population statistics data described above, and the like). The analysis result data storage unit 150 stores data showing a data analysis result (analysis result data) by the data analysis device 10. Note that details of the purchase data and the population statistics data that are examples of the related data will be described later.

The data analysis processing unit 110 performs data analysis of a comparison target month with an analysis target combination according to a scenario defined in advance, based on the purchase data stored in the purchase data storage unit 130, and creates analysis result data including an attribute in which a peculiar point exists and output character strings indicating a reason why the peculiar point exists in the attribute (that is, an interpretation of a data analysis result). At this time, the data analysis processing unit 110 also uses the related data stored in the related data storage unit 140 as necessary to perform the data analysis. Note that the analysis result data is stored into the analysis result data storage unit 150 by the data analysis processing unit 110.

Further, the data analysis processing unit 110 performs analysis of a correlation between the attribute in which the peculiar point exists, and the related data.

The report display processing unit 120 creates the analysis result report including the attributes in which the peculiar point exists and the output character strings indicating the reason why the peculiar point exists in the attribute, based on the analysis result data stored in the analysis result data storage unit 150, and causes the analysis result report to be displayed on the report display terminal 30. At this time, the report display processing unit 120 creates the analysis result report periodically (for example, every month or the like) and causes the analysis result report to be displayed on the report display terminal 30 (therefore, data analysis by the data analysis processing unit 110 is also periodically performed).

Note that the configuration of the data analysis system 1 shown in FIG. 1 is an example, and other configurations may be adopted. For example, the report display terminal 30 may not be included in the data analysis system 1, and the analysis result report may be displayed on the store terminal 20. Further, for example, the population statistics management server 40 may not be included in the data analysis system 1.

[Purchase Data]

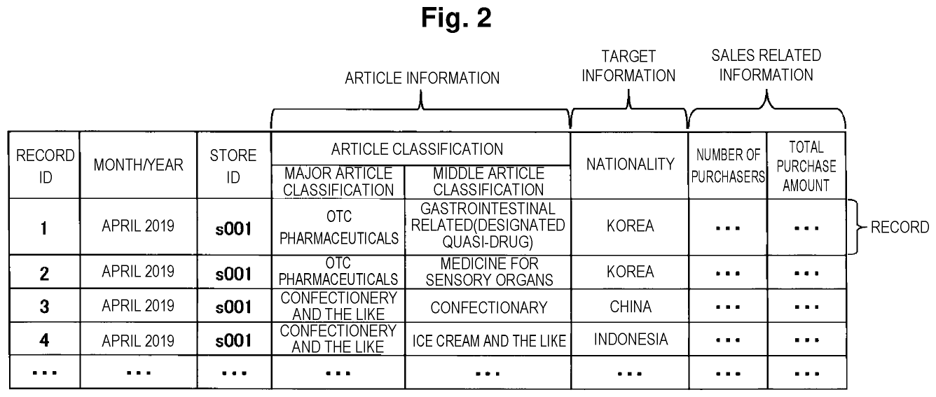

Here, the purchase data stored in the purchase data storage unit 130 will be described with reference to FIG. 2. FIG. 2 is a diagram showing an example of the purchase data. In FIG. 2, as an example, purchase data indicating a monthly number of purchasers and total purchase amount for each article classification and for each purchaser nationality at a certain store are described.

As shown in FIG. 2, the purchase data includes one or more records. Further, each of the records includes a record ID, month/year, a store ID, article classifications, a nationality, the number of purchasers and a total purchase amount) as attributes (that is, data items).

The record ID is an ID (identification information) that identifies each of records constituting the purchase data. The month/year is a year and month in which the number of purchasers and a total purchase amount are aggregated for each article classification and for each purchaser nationality. The store ID is an ID (identification information) that identifies each store.

The article classifications are article classifications defined, for example, by JICF or the like. In the example shown in FIG. 2, major article classification and middle article classification are included as the article classifications.

The nationality indicates a nationality of purchasers of each article. The number of purchasers indicates a total number of the purchasers. The total purchase amount indicates a total of purchase prices the purchasers paid to purchase the article (that is, sales).

Note that, among the attributes included in the purchase data, attributes such as the article classifications, attributes such as the purchaser nationality, and attributes such as the number of purchasers and the total purchase amount are also indicated as “article information”, “target information” and “sales related information”, respectively. As the article information, for example, article name, article ID and the like are provided in addition to the article classifications. Further, as the target information, for example, gender, race, age and the like are provided in addition to nationality. As the sales information, for example, average purchase price, average purchase amount, month-to-month ratio for total purchase amount, month-to-month ratio for the number of purchasers, month-to-month ratio for average purchase price, month-to-month ratio for average purchase amount, and the like are provided in addition to the number of purchasers and the total purchase amount.

Therefore, the purchase data refers to data configured with records each of which includes the sales information and at least one of the article information and the target information as attributes, the records being obtained by performing a predetermined aggregation process for a predetermined period (for example, a day, a week, a month, a year or the like). Note that, according to purposes of data analysis, for example, purchase data configured with records each of which includes two pieces of information, the sales information and the target information as attributes may be used, purchase data configured with records each of which includes two pieces of information, the sales information and the article information as attributes may be used, or purchase data configured with records each of which includes three pieces of information, the sales information, the article information and the target information as attributes may be used.

Further, what kinds of attributes are specifically used as the article information, the target information and the sales related information, respectively (that is, for example, whether only “nationality” is to be used or two of “nationality” and “age” are to be used as the target information, and the like) also differs according to purposes of data analysis, characteristics of articles sold by each store, and the like.

[Population Statistics Data]

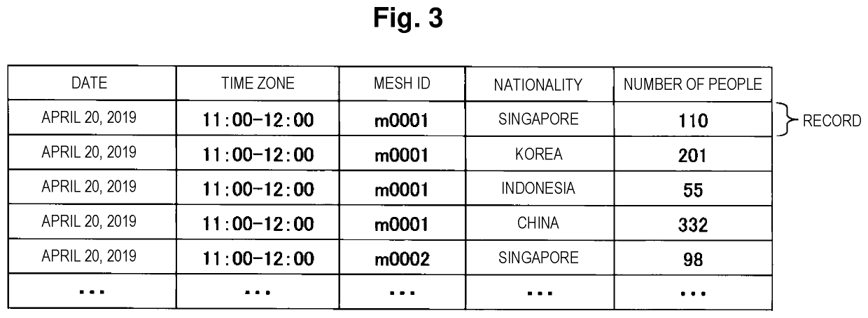

Next, the population statistics data, which are an example of the related data stored in the related data storage unit 140, will be described with reference to FIG. 3. FIG. 3 is a diagram showing an example of the population statistics data.

As shown in FIG. 3, the population statistics data includes one or more records. Further, each of the records includes a date, a time zone, a mesh ID, a nationality and the number of people as attributes (that is, data items).

The date and the time zone are a date and time zone targeted by population statistics. The mesh ID is an ID (identification information) that identifies each mesh (that is, a geographical area specified in advance). Note that, though the mesh is often specified, for example, as a 500 m to a few km square rectangular area, any area specified in advance can be caused to be the mesh.

The nationality and the number of people are a nationality and the number of people who stayed in the mesh on the date and time zone.

Thus, the population statistics data are data configured with records each of which includes the nationality and number of people who stayed in a mesh for each date and time zone. By using such population statistics data, it is possible to, for example, when a peculiar point exists in the attribute “the number of purchasers” of the purchase data, analyze that the population around the store is large (or small) and the like as described later.

[Hardware Configuration]

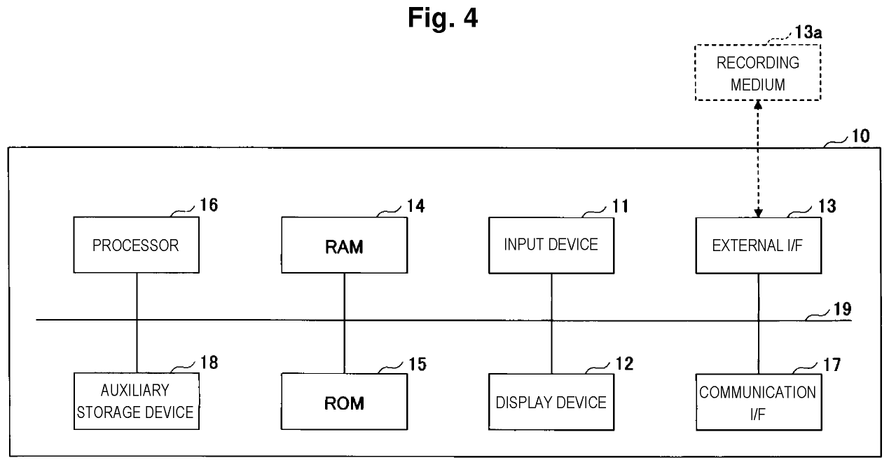

Next, a hardware configuration of the data analysis device 10 in the embodiment of the present invention will be described with reference to FIG. 4. FIG. 4 is a diagram showing an example of the hardware configuration of the data analysis device 10 in the embodiment of the present invention. Note that each of the store terminals 20, the report display terminals 30, the population statistics management servers 40 and the like can be implemented by a hardware configuration similar to that of the data analysis device 10.

As shown in FIG. 4, the data analysis device 10 in the embodiment of the present invention includes an input device 11, a display device 12, an external I/F 13, a RAM (random access memory) 14, a ROM (read-only memory) 15, a processor 16, a communication I/F 17 and an auxiliary storage device 18, as a hardware. These pieces of hardware are communicably connected via a bus 19.

The input device 11 is, for example, a keyboard and a mouse, a touch panel, or the like and used for a user to perform various kinds of input operations. The display device 12 is, for example, a display or the like, and displays a processing result and the like of the data analysis device 10. Note that the data analysis device 10 may not include at least one of the input device 11 and the display device 12.

The external I/F 13 is an interface with external devices. The external devices include a recording medium 13a and the like. The data analysis device 10 can perform reading from and writing to the recording medium 13a via the external I/F 13. In the recording medium 13a, for example, one or more programs and the like to implement the data analysis processing unit 110 and the report display processing unit 120 may be recorded.

As the recording medium 13a, for example, a flexible disk, a CD (compact disc), a DVD (digital versatile disk), an SD memory card (secure digital memory card), a USB (universal serial bus), a memory card and the like are included.

The RAM 14 is a volatile semiconductor memory that temporarily holds programs and data. The ROM 15 is a nonvolatile semiconductor memory capable of holding programs and data even if power is turned off. In the ROM 15, for example, setting information about an OS (operating system), setting information about a communication network and the like are stored.

The processor 16 is, for example, a CPU (central processing unit) or the like and is an arithmetic unit that reads out a program and data from the ROM 15, the auxiliary storage device 18 and the like onto the RAM 14 and executes a process. The data analysis processing unit 110 and the report display processing unit 120 are implemented by reading out one or more programs stored in the ROM 15, the auxiliary storage device 18 and the like on the RAM 14, and causing the processor 16 to execute processes.

The communication I/F 17 is an interface for connecting the data analysis device 10 to the communication network. The one or more programs that implement the data analysis processing unit 110 and the report display processing unit 120 may be acquired (downloaded) from a predetermined server device or the like via the communication I/F 17.

The auxiliary storage device 18 is, for example, an HDD (hard disk drive), an SSD (solid state drive) or the like and is a nonvolatile storage device that stores programs and data. The programs and data stored in the auxiliary storage device 18 include, for example, the OS, application programs that implement various kinds of functions on the OS, one or more programs that implement the data analysis processing unit 110 and the report display processing unit 120, and the like.

Further, the purchase data storage unit 130, the related data storage unit 140 and the analysis result data storage unit 150 can be implemented, for example, with the auxiliary storage device 18. However, at least one storage unit among the purchase data storage unit 130, the related data storage unit 140 and the analysis result data storage unit 150 may be implemented with a storage device or the like connected to the data analysis device 10 via the communication network.

By having the hardware configuration shown in FIG. 4, the data analysis device 10 in the embodiment of the present invention can implement various kinds of processes described later. Note that, though a case where the data analysis device 10 in the embodiment of the present invention is implemented by one device (computer) is shown in the example shown in FIG. 4, the data analysis device 10 is not limited thereto. The data analysis device 10 in the embodiment of the present invention may be implemented by a plurality of devices (computers). Further, the one device (computer) may include a plurality of processors 16 and a plurality of memories (the RAM 14, the ROM 15, the auxiliary storage device 18 and the like).

[Outline of Data Analysis]

Here, an outline of data analysis performed by the data analysis device 10 in the embodiment of the present invention will be described. In the embodiment of the present invention, a description will be made on a case where data analysis is performed with purchase data of a certain store as an analysis target (in other words, a report target of the analysis result report) (data analysis for each store), and a case where data analysis is performed with (purchase data obtained by aggregating) purchase data of all stores in a certain area as an analysis target (data analysis for grasp of overall trend).

Note that the analysis target is not limited to a store or all the stores in the area but may be, for example, particular stores or the like in a certain area or particular stores among stores operated by a certain company. Further, the area may be, for example, a range identified by a latitude, a longitude and the like, a range identified by an administrative division such as a municipality, or a range identified by a mesh.

(For Each Store)

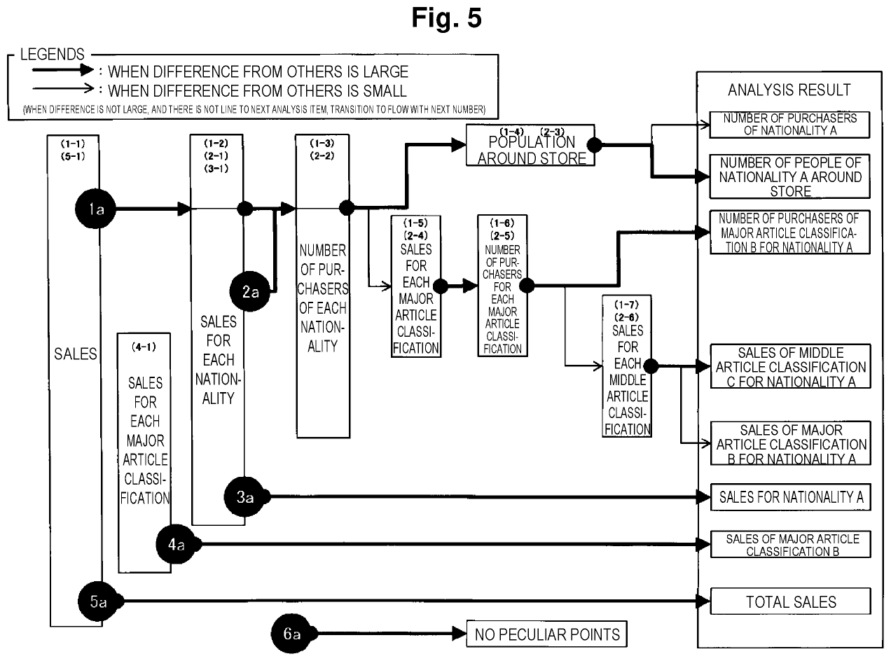

First, an outline of the data analysis for each store will be described with reference to FIG. 5. FIG. 5 is a diagram for illustrating the outline of the data analysis (for each store) in the embodiment of the present invention. In the example shown in FIG. 5, the comparison target pair is assumed to be monthly purchase data of a user's own store and purchase data of the same month in another store.

In the data analysis for each store, the data analysis is performed by flows 1a to 6a as shown in FIG. 5. Hereinafter, it is assumed that the monthly purchase data includes “major article classification”, “middle article classification”, “nationality”, “the number of purchasers” and “total purchase amount” as an attribute. Note that the number of purchasers and the total purchase amount refer to a total number of people of the nationality who purchased articles belonging to the major article classification and the middle article classification at the relevant store during the month and a total of purchase prices, respectively.

Flow 1a

First, in the flow 1a, data analysis is performed by (1-1) to (1-7) below. Note that a case where a peculiar point exists in a certain attribute refers to a case where there is a difference equal to or larger than a predetermined difference between the attribute of the monthly purchase data of the user's own store and the attribute of the purchase data of the same month in the other store as described above.

(1-1) First, it is analyzed whether or not a peculiar point exists in sales (that is, a total of all total purchase amounts of the user's own store in the current month) with “sales” as an analysis target combination. Then, if a peculiar point exists in the sales, analysis of (1-2) is performed. On the other hand, if no peculiar point exists in the sales, data analysis of the flow 2a is performed.

(1-2) When the peculiar point exists in the sales, it is analyzed whether or not a peculiar point exists in sales for each nationality, with “sales” and “nationality” as an analysis target combination. Then, if a peculiar point exists in the sales for each nationality, analysis of (1-3) is performed. On the other hand, if no peculiar point exists in the sales for each nationality, the data analysis of the flow 2a is performed. Hereinafter, a nationality for which it has been analyzed in (1-2) that there is a peculiar point will be referred to as “a nationality A” for simplification.

(1-3) When the peculiar point exists in the sales for the nationality A, it is analyzed whether or not a peculiar point exists in the number of purchasers of the nationality A, with “sales”, “nationality” and “the number of purchasers” as an analysis target combination. Then, if a peculiar point exists in the number of purchasers of the nationality A, analysis of (1-4) is performed. On the other hand, if no peculiar point exists in the number of purchasers of the nationality A, analysis of (1-5) is performed.

(1-4) When the peculiar point exists in the number of purchasers of the nationality A, it is analyzed whether or not a peculiar point exists in the number of people of the nationality A around the user's own store, from the population (the number of people) of the nationality A around the user's own store and the population (the number of people) of the nationality A in the whole area, using the number of people of the nationality A in the population statistics data (that is, with “nationality” and “the number of people” in the population statistics data as an analysis target combination). Then, if no peculiar point exists, “the number of purchasers of the nationality A” in which it has been analyzed in (1-3) described above that a peculiar point exists is set as an analysis result (that is, a peculiar point to which a user should pay attention). On the other hand, if the peculiar point exists, “the number of people of the nationality A around the user's own store” in which it has been analyzed in (1-3) described above that a peculiar point exists, is set as an analysis result. Note that, at this time, analysis result data that includes the analysis result and output character strings indicating a reason why the peculiar point exists in the attribute obtained as the analysis result.

(1-5) When no peculiar point exists in the number of purchasers of the nationality A, it is analyzed whether or not a peculiar point exists in sales of each major article classification for the nationality A in which it has been analyzed in (1-2) above that a peculiar point exists, with “sales”, “nationality” and “major article classification” as an analysis target combination. Then, if a peculiar point exists in the sales of each major article classification for the nationality A, analysis of (1-6) is performed. On the other hand, if no peculiar point exists in the sales of each major article classification for the nationality A, the data analysis of the flow 2a is performed. Hereinafter, a major article classification in which it has been analyzed in (1-5) that there is a peculiar point will be referred to as “a major article classification B” for simplification.

(1-6) When the peculiar point exists in the major article classification B for the nationality A, it is analyzed whether or not a peculiar point exists in the number of purchasers of the major article classification B for the nationality A, with “sales”, “nationality”, “the number of purchasers” and “major article classification” as an analysis target combination. Then, if a peculiar point exists in the number of purchasers of the major article classification B for the nationality A, “the number of purchasers of the major article classification B for the nationality A” is set as an analysis result. On the other hand, if no peculiar point exists in the number of purchasers of the major article classification B for the nationality A, analysis of (1-7) is performed.

(1-7) When no peculiar point exists in the number of purchasers of the major article classification B for the nationality A, it is analyzed whether or not a peculiar point exists in sales of each middle article classification for the nationality A, with “sales”, “nationality”, “major article classification” and “middle article classification” as an analysis target combination. Hereinafter, a middle article classification in which it has been analyzed in (1-7) that a peculiar point exists will be referred to as “a middle article classification C” for simplification.

Then, if a peculiar point exists in the sales of each middle article classification for the nationality A, “the sales of the middle article classification C for the nationality A” is set as an analysis result. On the other hand, if no peculiar point exists in the sales of the middle article classification for the nationality A, “the sales of the major article classification B for the nationality A” is set as an analysis result. This is because there is a peculiar point neither in the sales of middle article classification for the nationality A nor in the number of purchasers of the major article classification B for the nationality A.

Flow 2a

Next, in the flow 2a, data analysis is performed by (2-1) to (2-6) below.

(2-1) First, it is analyzed whether or not a peculiar point exists in the sales for each nationality, with “sales” and “nationality” as an analysis target combination. Then, if a peculiar point exists in the sales for each nationality, analysis of (2-2) is performed. On the other hand, if no peculiar point exists in the sales for each nationality, data analysis of the flow 3a is performed. Hereinafter, a nationality in which it has been analyzed in (2-1) that there is a peculiar point will be referred to as “a nationality A” for simplification.

(2-2) Then, when the peculiar point exists in the sales for the nationality A, it is analyzed whether or not a peculiar point exists in the number of purchasers of the nationality A, with “sales”, “nationality” and “the number of purchasers” as an analysis target combination. Then, if a peculiar point exists in the number of purchasers of the nationality A, analysis of (2-3) is performed. On the other hand, if no peculiar point exists in the number of purchasers of the nationality A, analysis of (2-4) is performed.

(2-3) When the peculiar point exists in the number of purchasers of the nationality A, it is analyzed whether or not a peculiar point exists in the number of people of the nationality A around the user's own store, from the population (the number of people) of the nationality A around the user's own store and the population (the number of people) of the nationality A in the whole area, using the number of people of the nationality A in the population statistics data (that is, with “nationality” and “the number of people” in the population statistics data as an analysis target combination). Then, if no peculiar point exists, “the number of purchasers of the nationality A” in which it has been analyzed in (2-2) described above that a peculiar point exists is set as an analysis result (that is, a peculiar point that the user should pay attention to). On the other hand, if the peculiar point exists, “the number of people of the nationality A around the user's own store” in which it has been analyzed in (2-2) described above that a peculiar point exists is set as an analysis result.

(2-4) When no peculiar point exists in the number of purchasers of the nationality A, it is analyzed whether or not a peculiar point exists in the sales of each major article classification for the nationality A in which it has been analyzed in (2-1) above that a peculiar point exists, with “sales”, “nationality” and “major article classification” as an analysis target combination. Then, if a peculiar point exists in the sales of each major article classification for the nationality A, analysis of (2-5) is performed. On the other hand, if no peculiar point exists in the sales of each major article classification for the nationality A, the data analysis of the flow 3a is performed. Hereinafter, a major article classification in which it has been analyzed in (2-4) that there is a peculiar point will be referred to as “a major article classification B” for simplification.

(2-5) When the peculiar point exists in the major article classification B for the nationality A, it is analyzed whether or not there is a peculiar point in the number of purchasers of the major article classification B for the nationality A, with “sales”, “nationality”, “major article classification” and “the number of purchasers” as an analysis target combination. Then, if a peculiar point exists in the number of purchasers of the major article classification B for the nationality A, “the number of purchasers of the major article classification B for the nationality A” is set as an analysis result. On the other hand, if no peculiar point exists in the number of purchasers of the major article classification B for the nationality A, analysis of (2-6) is performed.

(2-6) When no peculiar point exists in the number of purchasers of the major article classification B for the nationality A, it is analyzed whether or not a peculiar point exists in the sales of each middle article classification for the nationality A, with “sales”, “nationality”, “major article classification” and “middle article classification” as an analysis target combination. Hereinafter, a middle article classification in which it has been analyzed in (2-6) that a peculiar point exists will be referred to as “a middle article classification C” for simplification.

Then, if a peculiar point exists in the sales of each middle article classification for the nationality A, “the sales of the middle article classification C for the nationality A” is set as an analysis result. On the other hand, if no peculiar point exists in the sales of the middle article classification for the nationality A, “the sales of the major article classification B for the nationality A” is set as an analysis result.

Flow 3a

Next, in the flow 3a, data analysis is performed by (3-1) below.

(3-1) It is analyzed whether or not a peculiar point exists in the sales for each nationality, with “sales” and “nationality” as an analysis target combination. Then, if a peculiar point exists in the sales for each nationality (the nationality in which the peculiar point exists is referred to as “a nationality A”), “sales for the nationality A” is set as an analysis result. On the other hand, if no peculiar point exists in the sales for each nationality, data analysis of the flow 4a is performed.

Flow 4a

Next, in the flow 4a, data analysis is performed by (4-1) below.

(4-1) It is analyzed whether or not a peculiar point exists in the sales of each major article classification, with “sales” and “major article classification” as an analysis target combination. Then, if a peculiar point exists in the sales of each major article classification (the major article classification in which the peculiar point exists is referred to as “a major article classification B”), “sales of the major article classification B” is set as an analysis result. On the other hand, if no peculiar point exists in the sales of each major article classification, data analysis of the flow 5a is performed.

Flow 5a

Next, in the flow 5a, data analysis is performed by (5-1) below.

(5-1) It is analyzed whether or not a peculiar point exists in the sales (that is, total sales of the current month of the user's own store), with “sales” as an analysis target combination. Then, if a peculiar point exists in the sales, “the total sales” is set as an analysis result. On the other hand, if no peculiar point exists in the sales, data analysis of the flow 6a is performed.

Flow 6a

Lastly, in the flow 6a, “no peculiar points” is set as an analysis result. This is because, in this case, no peculiar point exists in the purchase data by the analyses according to the flows 1a to 5a described above.

Thus, in the embodiment of the present invention, the flows 1a to 6a are defined as a scenario of the data analysis for each store, and the data analysis for each store is performed by these flows 1a to 6a. In these flows 1a to 6a, analysis granularity becomes finer from left to right in the same flow in FIG. 5. Meanwhile, analysis granularity becomes finer in order from the flow 1a to the flow 6a.

For example, in the flow 1a, while the data analysis is performed using only “sales” included in the analysis target combination in (1-1), the data analysis is performed using “sales” and “nationality” included in the analysis target combination in (1-2). Therefore, the data granularity of the data analysis in (1-2) is finer than the data analysis in (1-1). Thus, in the flow 1a, the data analysis is performed while the analysis granularity is caused to be gradually finer, in such order of “sales”→“sales”×“nationality”→“sales”×“nationality”×“the number of purchasers”→ . . . . This is because, even if a peculiar point exists when the granularity is fine, influence on the whole is small if no peculiar point exists when the granularity is large, and a possibility that it becomes a business problem is weak. Thereby, effective and efficient data analysis for each store becomes possible.

Note that it is an example to define the flows 1a to 6a as a scenario of the data analysis for each store, and it is possible to define various kinds of flows other than these flows 1a to 6a as a scenario. At this time, it is preferable that the definition is made so that data analysis is performed, for example, in order of (1) a flow of analyzing sales related information×target information×article information (the flows 1a and 2a), (2) a flow of analyzing sales related information×target information (the flow 3a), (3) a flow of analyzing sales related information×article information (the flow 4a) and (4) a flow of analyzing sales related information (the flow 5a). Further, at this time, a combination of a plurality of attributes may be used as each piece of information (for example, both of “sales” and “the number of purchasers” are used as the sales related information, both of “nationality” and “gender” are used as the target information, and so on).

Further, in the embodiment of the present invention, though a description is made on the assumption that the data analyses of (1-4) and (2-3) above are performed, these data analyses (that is, data analyses using the population statistics data) do not necessarily have to be performed.

(Understanding of Overall Trend)

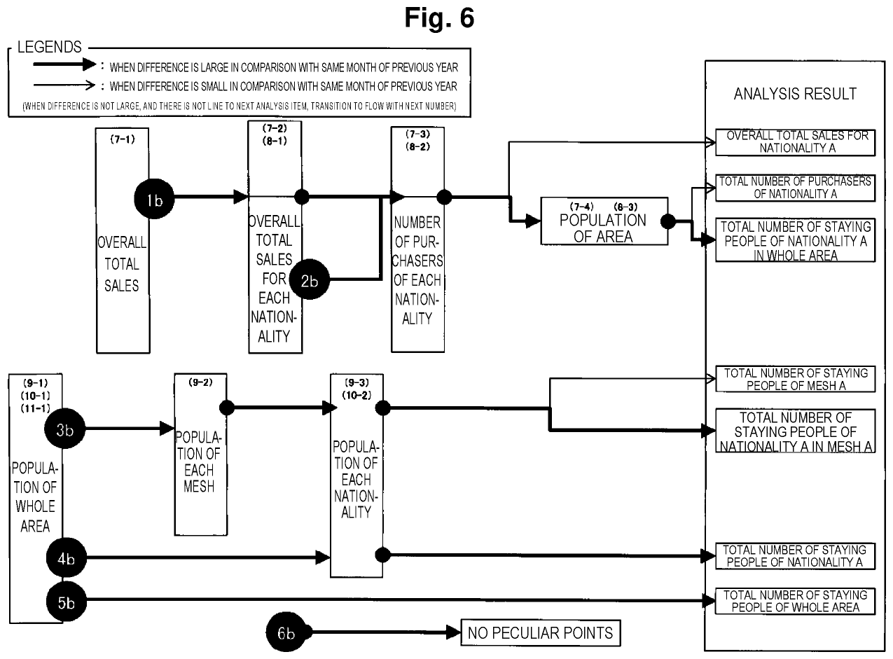

Next, an outline of the data analysis for understanding of overall trend will be described with reference to FIG. 6. FIG. 6 is a diagram for illustrating an outline of the data analysis (for understanding of overall trend) in the embodiment of the present invention. In the example shown in FIG. 6, it is assumed that the comparison target pair is data obtained by aggregating monthly purchase data of all the stores in the area (this data will be referred to as “all stores purchase data” for simplification) and all stores purchase data of the same month of the previous year).

In the data analysis for understanding of overall trend, the data analysis is performed by flows 1b to 6b as shown in FIG. 6.

Flow 1b

First, in the flow 1b, the data analysis is performed by (7-1) to (7-4) below. Note that the case where a peculiar point exists in a certain attribute refers to the case where there is a difference equal to or larger than a predetermined difference between the attribute of the monthly all stores purchase data and the attribute of the all stores purchase data of the same month of the previous year as described above. Hereinafter, it is assumed that the monthly all stores purchase data includes “nationality”, “the number of purchasers” and “total purchase amount” are included as attributes. Note that the number of purchasers and the total purchase amount refer to a total of the numbers of people of the nationality who purchased the article in all the stores in the area during the relevant month, and a total of total purchase amounts, respectively.

(7-1) First, it is analyzed whether or not a peculiar point exists in overall total sales (that is, a total of all the total purchase amounts in the current month) with “overall total sales” as an analysis target combination. Then, if a peculiar point exists in the overall total sales, analysis of (7-2) is performed. On the other hand, if no peculiar point exists in the overall total sales, data analysis of the flow 2b is performed.

(7-2) When the peculiar point exists in the overall total sales, it is analyzed whether or not a peculiar point exists in overall total sales for each nationality, with “overall total sales” and “nationality” as an analysis target combination. Then, if a peculiar point exists in the overall total sales for each nationality, analysis of (7-3) is performed. On the other hand, if no peculiar point exists in the overall total sales, the data analysis of the flow 2b is performed. Hereinafter, a nationality in which it has been analyzed in (7-2) that there is a peculiar point will be referred to as “a nationality A” for simplification.

(7-3) When the peculiar point exists in the overall total sales for the nationality A, it is analyzed whether or not a peculiar point exists in the number of purchasers of the nationality A, with “overall total sales”, “nationality” and “the number of purchasers” as an analysis target combination. Then, if a peculiar point exists in the number of purchasers of the nationality A, analysis of (7-4) is performed. On the other hand, if no peculiar point exists in the number of purchasers of the nationality A, “overall total sales for the nationality A” is set as an analysis result.

(7-4) When the peculiar point exists in the number of purchasers of the nationality A, it is analyzed whether or not a peculiar point exists in the number of people of the nationality A in the whole area in the current month, from the population (the number of people) of the nationality A in the whole area in the current month and the population (the number of people) of the nationality A in the whole area in the same month of the previous year, with the number of people of the nationality A in the population statistics data (that is, with “nationality” and “the number of people” in the population statistics data as an analysis target combination). Then, if no peculiar point exists, “the number of purchasers of the nationality A” in which it has been analyzed in (7-3) described above that a peculiar point exists is set as an analysis result. On the other hand, if the peculiar point exists, “a total number of staying people of the nationality A in the whole area” is set as an analysis result. This is because, in this case, the number of people of the nationality A in the whole area is increasing (or decreasing) in comparison with the same month of the previous year by a predetermined threshold or above.

Flow 2b

Next, in the flow 2b, data analysis is performed by (8-1) to (8-3) below.

(8-1) It is analyzed whether or not a peculiar point exists in the overall total sales for each nationality, with “overall total sales” and “nationality” as an analysis target combination. Then, if a peculiar point exists in the overall total sales for each nationality, analysis of (8-2) is performed. On the other hand, if no peculiar point exists in the overall total sales for each nationality, data analysis of the flow 3b is performed. Hereinafter, a nationality in which it has been analyzed in (8-1) that there is a peculiar point will be referred to as “a nationality A” for simplification.

(8-2) When the peculiar point exists in overall total sales for the nationality A, it is analyzed whether or not a peculiar point exists in the number of purchasers of the nationality A, with “overall total sales”, “nationality” and “the number of purchasers” as an analysis target combination. Then, if a peculiar point exists in the number of purchasers of the nationality A, analysis of (8-3) is performed. On the other hand, if no peculiar point exists in the number of purchasers of the nationality A, “overall total sales for the nationality A” is set as an analysis result.

(8-3) When the peculiar point exists in the number of purchasers of the nationality A, it is analyzed whether or not a peculiar point exists in the number of people of the nationality A in the whole area in the current month, from the population (the number of people) of the nationality A in the whole area in the current month and the population (the number of people) of the nationality A in the whole area in the same month of the previous year, using the number of people of the nationality A in the population statistics data (that is, with “nationality” and “the number of people” in the population statistics data as an analysis target combination). Then, if no peculiar point exists, “the number of purchasers of the nationality A” is set as an analysis result. On the other hand, if the peculiar point exists, “the total number of staying people of the nationality A in the whole area” is set as an analysis result.

Flow 3b

Next, in the flow 3b, data analysis is performed by (9-1) to (9-3) below.

(9-1) It is analyzed whether or not a peculiar point exists in the number of people of the whole area in the current month, from the population (the number of people) of the whole area in the current month and the population (the number of people) of the whole area in the same month of the previous year, using the number of people in the population statistics data (that is, with “the number of people” in the population statistics data as an analysis target combination). Then, if a peculiar point exists in the population of the whole area in the current month, analysis of (9-2) is performed. On the other hand, if no peculiar point exists in the population of the whole area in the current month, data analysis of the flow 4b is performed.

(9-2) When the peculiar point exists in the population of the whole area in the current month, it is analyzed whether or not a peculiar point exists in the population (the number of people) for each mesh between the current month and the same month of the previous year, using the number of people for each mesh in the population statistics data (that is, with “the number of people” and “mesh ID” in the population statistics data as an analysis target combination). Then, if the peculiar point exists, analysis of (9-3) is performed. On the other hand, if no peculiar point exists, the data analysis of the flow 4b is performed. Hereinafter, a mesh in which it has been analyzed in (9-2) that there is a peculiar point will be referred to as “a mesh A” for simplification.

(9-3) When the peculiar point exists in the population of the mesh A in the current month, it is analyzed whether or not a peculiar point exists in the population of each nationality in the mesh A between the current month and the same month of the previous year, using the number of people of each nationality in the mesh A in the population statistics data (that is, with “the number of people”, “nationality” and “mesh ID” in the population statistics data as an analysis target combination). Then, if the peculiar point exists (the nationality in which the peculiar point exists is referred to as “a nationality A”), “a total number of staying people of the nationality A in the mesh A” is set as an analysis result. On the other hand, if no peculiar point exists, “a total number of staying people in the mesh A” is set as an analysis result.

Flow 4b

Next, in the flow 4b, data analysis is performed by (10-1) to (10-2) below.

(10-1) It is analyzed whether or not a peculiar point exists in the number of people of the whole area in the current month, from the population (the number of people) of the whole area in the current month and the population (the number of people) of the whole area in the same month of the previous year, using the number of people in the population statistics data. Then, if a peculiar point exists in the population of the whole area in the current month, analysis of (10-2) is performed. On the other hand, if no peculiar point exists in the population of the whole area in the current month, data analysis of the flow 5b is performed.

(10-2) When the peculiar point exists in the population of the whole area in the current month, it is analyzed whether or not a peculiar point exists in the population (the number of people) of each nationality between the current month and the same month of the previous year, using the number of people of each nationality in the population statistics data. Then, if the peculiar point exists (the nationality in which the peculiar point exists is referred to as “a nationality A”), “a total number of staying people of the nationality A” is set as an analysis result. On the other hand, if no peculiar point exists, the data analysis of the flow 5b is performed.

Flow 5b

Next, in the flow 5b, data analysis is performed by (11-1) below.

(11-1) It is analyzed whether or not a peculiar point exists in the number of people of the whole area in the current month, from the population (the number of people) of the whole area in the current month and the population (the number of people) of the whole area in the same month of the previous year, using the number of people in the population statistics data. Then, if a peculiar point exists in the population of the whole area in the current month, “the number of staying people of the whole area” is set as an analysis result. On the other hand, if no peculiar point exists in the population of the whole area in the current month, data analysis of the flow 6b is performed.

Flow 6b

Lastly, in the flow 6b, “no peculiar points” is set as an analysis result. This is because, in this case, no peculiar point exists in the all stores purchase data by the analyses according to the flows 1b to 5b described above.

Thus, in the embodiment of the present invention, the flows 1b to 6b are defined as a scenario of the data analysis for understanding of overall trend, and the data analysis for understanding of overall trend is performed by these flows 1b to 6b. In these flows 1b to 6b, analysis granularity becomes finer from left to right in the same flow in FIG. 6.

Note that it is an example to define the flows 1b to 6b as a scenario of the data analysis for understanding of overall trend, and it is possible to define various kinds of flows other than these flows 1b to 6b as a scenario. At this time, it is preferable that the definition is made so that data analysis is performed, for example, in order of (1) a flow of analyzing sales related information×target information (the flows 1b and 2b) and (2) a flow of analyzing target information (the flows 3b to 5a). Further, at this time, a combination of a plurality of attributes may be used as each piece of information.

Further, in the embodiment of the present invention, though a description is made on the assumption that the data analyses of (7-4), (8-3), (9-1) to (9-4), (10-1) and (10-2), and (11-1) above are performed, these data analyses (that is, data analyses using the population statistics data) do not necessarily have to be performed.

[Data Analysis Process (for Each Store)]

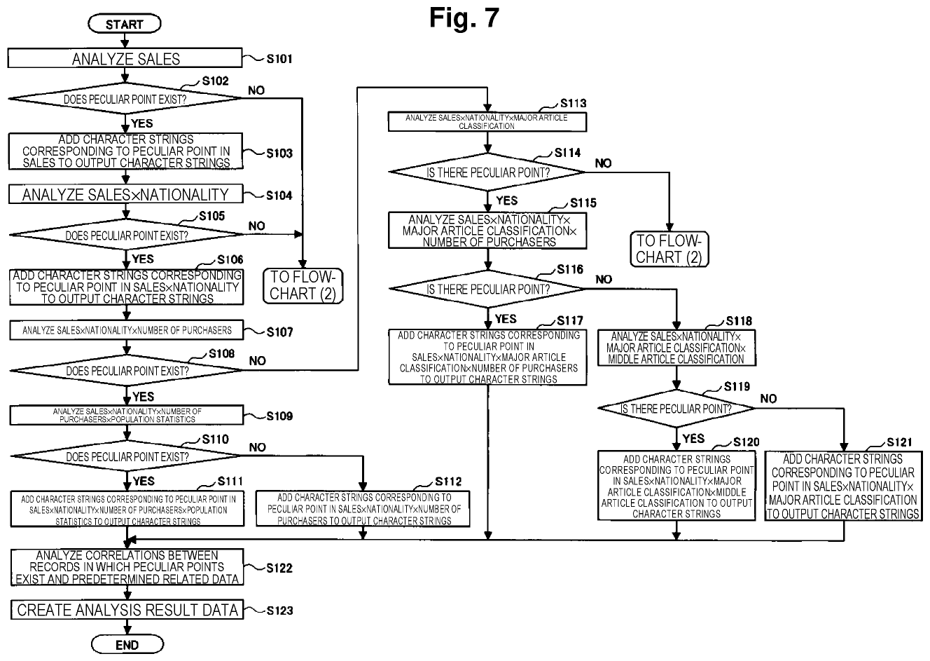

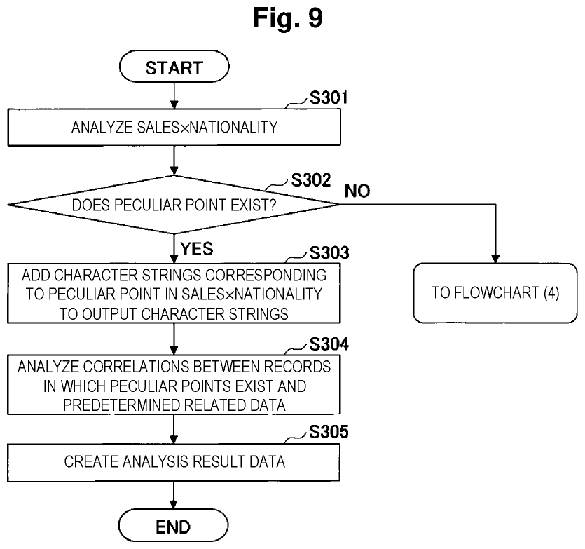

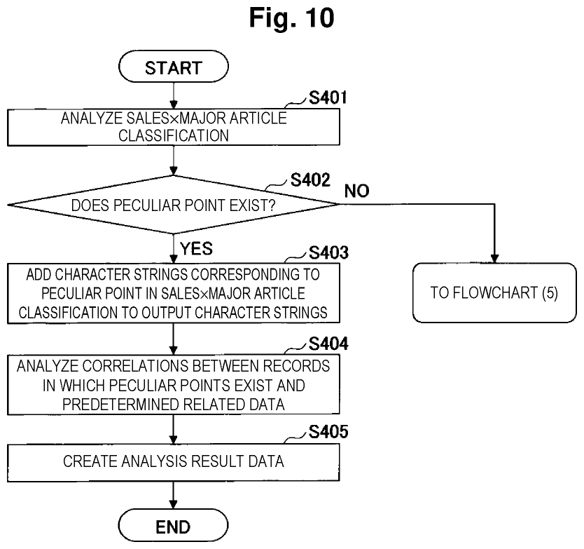

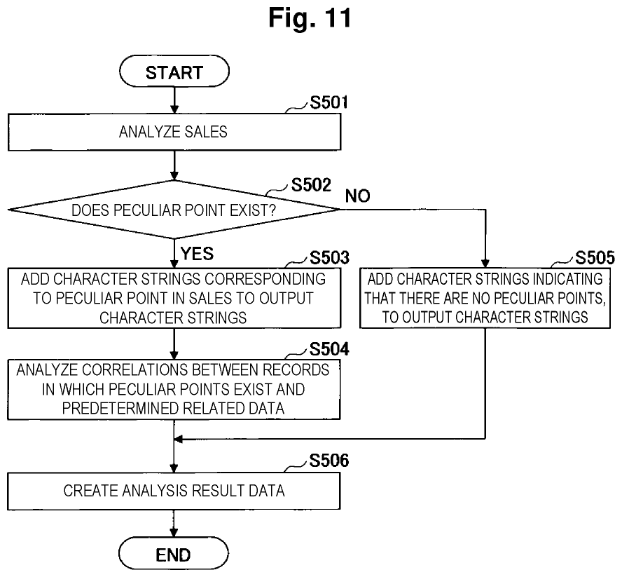

Hereinafter, a flow of a data analysis process for each store will be described with reference to FIGS. 7 to 11. FIGS. 7 to 11 are flowcharts (1) to (5) showing an example of the data analysis process for each store. Note that, as for these flowcharts (1) to (5), the flowcharts (1) to (4) correspond to the flows 1a to 4a shown in FIG. 5, respectively, and the flowchart (5) corresponds to the flowcharts 5a and 6a.

Further, hereinafter, it is assumed that the comparison target pair is “monthly purchase data of the user's own store and purchase data of another store in the same month”, and the monthly purchase data includes “major article classification”, “middle article classification”, “nationality”, “the number of purchasers” and “total purchase amount” as attributes, similarly to FIG. 5. These pieces of purchase data are stored in the purchase data storage unit 130. Note that the comparison target pair is set, for example, by the user.

(Flowchart (1))

First, the data analysis processing unit 110 analyzes whether or not a peculiar point exists in the sales (that is, the total of all the total purchase amounts of the user's own store in the current month) with “sales” as an analysis target combination (step S101). For example, if there is a difference in sales equal to or above a predetermined threshold between the user's own store and the other store, the data analysis processing unit 110 determines that a peculiar point exists in the sales in the purchase data of the current month of the user's own store. Note that a ratio may be used instead of the difference (the same goes for the time of analyzing existence of a peculiar point hereinafter).

Then, if no peculiar point exists in the sales (step S102: NO), the data analysis processing unit 110 executes the flowchart (2). On the other hand, if a peculiar point exists in the sales (step S102: YES), the data analysis processing unit 110 adds character strings corresponding to the peculiar point of the sales (for example, “Increasing against the previous month in comparison with sales of other store”, “Decreasing against the previous month in comparison with sales of other store” or the like) to output character strings (step S103). Note that, for example, which of “Increasing against the previous month in comparison with sales of the other store” and “Decreasing against the previous month in comparison with sales of the other store” is to be added to the output character strings is determined based on whether the sales of the user's own store has been analyzed to be high or low in comparison with the sales of the other store as a result of the analysis of step S101 described above. The same goes for the time of adding predetermined character strings to the output character strings hereinafter.

Subsequent to step S103, the data analysis processing unit 110 analyzes whether or not a peculiar point exists in the sales for each nationality, with “sales” and “nationality” as an analysis target combination (step S104). For example, if such a nationality that there is a difference equal to or above a predetermined threshold in the sales for each nationality between the user's own store and the other store, the data analysis processing unit 110 determines that a peculiar point exists in the sales for each nationality in the purchase data of the current month of the user's own store.

Then, if no peculiar point exists in the sales for each nationality (step S105: NO), the data analysis processing unit 110 executes the flowchart (2). On the other hand, if a peculiar point exists in the sales for each nationality (step S105: YES), the data analysis processing unit 110 adds character strings corresponding to the peculiar point of the sales for each nationality (hereinafter, a nationality in which the peculiar point exists will be referred to as “a nationality A”) (for example, “Sales for the nationality A is increasing in comparison with other store”, “Sales for the nationality A is decreasing in comparison with sales of other store”, or the like) to the output character strings (step S106).

Next, the data analysis processing unit 110 analyzes whether or not a peculiar point exists in the number of purchasers of the nationality A, with “sales”, “nationality” and “the number of purchasers” as an analysis target combination (step S107). For example, if there is a difference in the number of purchasers of the nationality A equal to or above a predetermined threshold between the user's own store and the other store, the data analysis processing unit 110 determines that a peculiar point exists in the number of purchasers of the nationality A in the purchase data of the current month of the user's own store.

Then, if a peculiar point exists in the number of purchasers of the nationality A (step S108: YES), the data analysis processing unit 110 analyzes whether or not a peculiar point exists in the number of people of the nationality A around the user's own store in the current month, from the number of people of the nationality A around the user's own store in the current month and the number of people of the nationality A in the whole area in the same month, with “nationality” and “the number of people” in the population statistics data stored in the related data storage unit 140 as an analysis target combination (step S109). For example, if there is a difference in the number of people of the nationality A in the current month equal to or above a predetermined threshold between an area around the user's own store and the whole area, the data analysis processing unit 110 determines that a peculiar point exists in the number of people of the nationality A around the user's own store. Note that, at this time, the data analysis processing unit 110 may determine that a peculiar point exists in a case where the number of people of the nationality A in the current month is increasing by a predetermined threshold or above (that is, a case where more people of the nationality A can be attracted to the user's own store than the other store, and the like).

Then, if a peculiar point exists in the number of people of the nationality A around the user's own store (step S110: YES), the data analysis processing unit 110 adds character strings corresponding to the peculiar point of the number of people of the nationality A around the user's own store (for example, “People of the nationality A could be attracted to the area around the user's own store unlike the other store”, “People of the nationality A are not around the user's own store unlike the other store”, or the like) to the output character strings (step S111).

On the other hand, if no peculiar point exists in the number of people of the nationality A around the user's own store (step S110: NO), the data analysis processing unit 110 adds character strings corresponding to the peculiar point of the number of purchasers of the nationality A in which it has been analyzed at step S107 above that a peculiar point exists (for example, “Purchasers of the nationality A are increasing unlike the other store”, “Purchasers of the nationality A are decreasing unlike the other store”, or the like) to the output character strings (step S112).

In the case of NO at step S108 above (that is, in a case where no peculiar point exists in the number of purchasers of the nationality A), the data analysis processing unit 110 analyzes whether or not a peculiar point exists in the sales of each major article classification for the nationality A (step S113) with “sales”, “nationality” and “major article classification” as an analysis target combination (step S113). Hereinafter, when it is analyzed at this step that a peculiar point exists, a major article classification in which the peculiar point exists will be referred to as “a major article classification B”.

Then, if a peculiar point exists in the sales of each major article classification for the nationality A (step S114: YES), the data analysis processing unit 110 analyzes whether or not a peculiar point exists in the number of purchasers of the major article classification B for the nationality A, with “sales”, “nationality”, “major article classification” and “the number of purchasers” as an analysis target combination (step S115).

On the other hand, if no peculiar point exists in the sales of each major article classification for the nationality A (step S114: NO), the data analysis processing unit 110 executes the flowchart (2).

If a peculiar point exists in the number of purchasers of the major article classification B for the nationality A (step S116: YES), the data analysis processing unit 110 adds character strings corresponding to the peculiar point of the number of purchasers of the major article classification B for the nationality A (for example, “The number of purchasers of the major article classification B is increasing especially for the nationality A”, “The number of purchasers of the major article classification B is decreasing especially for the nationality A”, or the like) to the output character strings (step S117).

On the other hand, if no peculiar point exists in the number of purchasers of the major article classification B for the nationality A (step S116: NO), the data analysis processing unit 110 analyzes whether or not a peculiar point exists in the sales of each middle article classification of the major article classification B for the nationality A, with “sales”, “nationality”, “major article classification” and “middle article classification” as an analysis target combination (step S118). Hereinafter, when it is analyzed at this step that a peculiar point exists, a middle article classification in which the peculiar point exists will be referred to as “a middle article classification C”.

If a peculiar point exists in the sales of each middle article classification of the major article classification B for the nationality A (step S119: YES), the data analysis processing unit 110 adds character strings corresponding to the peculiar point of the middle article classification C of the major article classification B for the nationality A (for example, “Sales of the middle article classification C of the major article classification B are increasing especially for the nationality A”, “Sales of the middle article classification C of the major article classification B are decreasing especially for the nationality A”, or the like) to the output character strings (step S120).

On the other hand, if no peculiar point exists in the sales of each middle article classification of the major article classification B for the nationality A (step S119: NO), the data analysis processing unit 110 adds character strings corresponding to the peculiar point of the sales of the major article classification B for the nationality A (for example, “The sales of the major article classification B are increasing especially for the nationality A”, “The sales of the major article classification B are decreasing especially for the nationality A”, or the like) to the output character strings (step S121).

Subsequent to step S111, S112, S117, S120 or S121, the data analysis processing unit 110 analyzes correlations between records in which peculiar points exist (records in the purchase data) and the related data stored in the related data storage unit 140 (step S122). Here, as the related data, for example, various kinds of data such as data obtained by aggregating messages and the like posted to SNS's, and data about visitors to tourist facilities. By analyzing the correlations between the records in which peculiar points exist and their related data, it becomes possible to extract elements having some relation with the peculiar points (for example, an event, an incident, a matter and the like). Note that a result of the correlation analysis is, for example, coefficients of correlations with the related data.

Lastly, the data analysis processing unit 110 creates analysis result data that includes the peculiar points of the purchase data, the output character strings to which the character strings corresponding to the peculiar points are added, and the result of the correlation analysis (step S123). Note that this analysis result data is stored into the analysis result data storage unit 150.

(Flowchart (2))

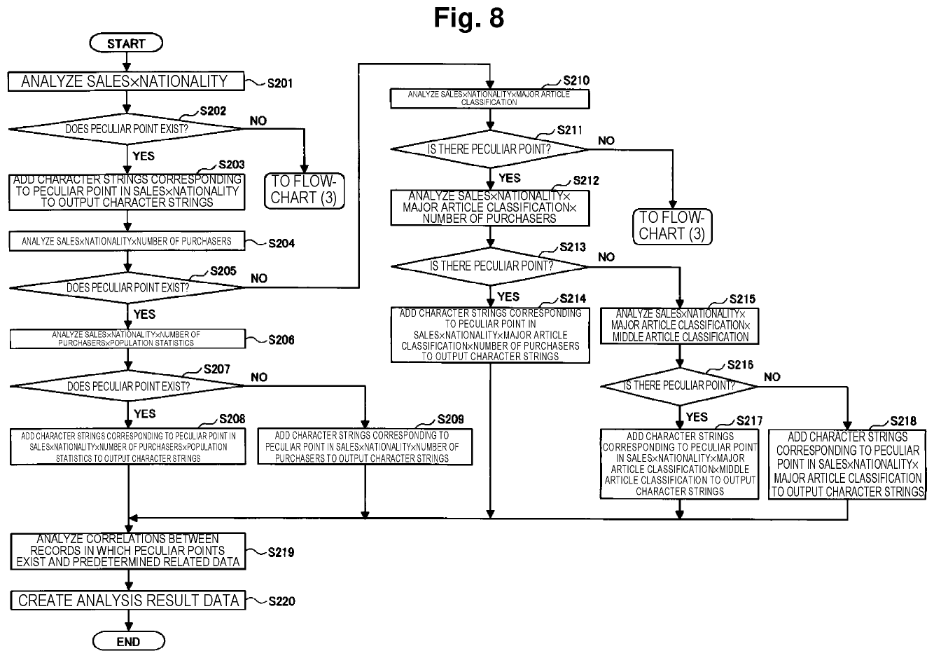

Steps S201 to S220 of FIG. 8 are similar to steps S104 to S123 of FIG. 7, respectively, except that the attribute “sales” is not a peculiar point. In the flowchart (2), however, the data analysis processing unit 110 executes the flowchart (3) in the case of NO at step S202 and in the case of NO at step S211. Note that the case of the flowchart (2) being executed is, for example, a case where there are no peculiar points in sales in comparison with the other store (that is, the sales are almost similar to sales of the other store), but there is a difference in the sales for each nationality.

(Flowchart (3))

First, the data analysis processing unit 110 analyzes whether or not a peculiar point exists in the sales for each nationality, with “sales” and “nationality” as an analysis target combination (step S301). Hereinafter, when it is analyzed at this step that a peculiar point exists, a nationality in which the peculiar point exists will be referred to as “a nationality A”.

Then, when the peculiar point exists in the sales for the nationality A (step S302: YES), the data analysis processing unit 110 adds character strings corresponding to the peculiar point of the sales for each nationality (that is, the sales for the nationality A) (for example, “Sales for the nationality A is increasing against the previous month in comparison with the other store”, “Sales for the nationality A is decreasing against the previous month in comparison with the other store”, or the like) to output character strings (step S303). Further, at this time, the data analysis processing unit 110 may further add character strings, “It was not found that, in the sales for the nationality A, a particular article classification influences the sales” to the output character strings.

On the other hand, if no peculiar point exists in the sales for the nationality A (step S302: NO), the data analysis processing unit 110 executes the flowchart (4).

Subsequent to step S303, the data analysis processing unit 110 analyzes correlations between records in which peculiar points exist (records in the purchase data) and the related data stored in the related data storage unit 140 similarly to step S122 of FIG. 7 (step S304).

Lastly, the data analysis processing unit 110 creates analysis result data similarly to step S123 of FIG. 7 (step S305).

(Flowchart (4))

First, the data analysis processing unit 110 analyzes whether or not a peculiar point exists in the sales of each major article classification, with “sales” and “major article classification” as an analysis target combination (step S401). Hereinafter, when it is analyzed at this step that a peculiar point exists, a major article classification in which the peculiar point exists will be referred to as “a major article classification B”.

Then, if a peculiar point exists in the sales of each major article classification (step S403: YES), the data analysis processing unit 110 adds character strings corresponding to the peculiar point of the sales of each major article classification (that is, the sales of the major article classification B) (for example, “Sales of the major article classification B is increasing against the previous month in comparison with the other store”, “Sales of the major article classification B is decreasing against the previous month in comparison with the other store”, or the like) to output character strings (step S403). Further, at this time, the data analysis processing unit 110 may further add character strings, “It was not found that, in the sales of the major article classification B, a particular nationality influences the sales” to the output character strings.

On the other hand, if no peculiar point exists in the sales of each major article classification (step S403: NO), the data analysis processing unit 110 executes the flowchart (5).

Subsequent to step S403, the data analysis processing unit 110 analyzes correlations between records in which peculiar points exist (records in the purchase data) and the related data stored in the related data storage unit 140 similarly to step S122 of FIG. 7 (step S404).

Lastly, the data analysis processing unit 110 creates analysis result data similarly to step S123 of FIG. 7 (step S405).

(Flowchart (5))

First, the data analysis processing unit 110 analyzes whether or not a peculiar point exists in the sales (that is, total sales of the user's own store in the current month), with “sales” as an analysis target combination (step S501).

Then, if a peculiar point exists in the sales (step S502: YES), the data analysis processing unit 110 adds character strings corresponding to the peculiar point of the sales (for example, “Sales are increasing against the previous month in comparison with the other store”, “Sales are decreasing against the previous month in comparison with the other store” or the like) to output character strings (step S503). Further, at this time, the data analysis processing unit 110 may further add character strings, “A nationality or a major article classification with a peculiar point influencing the sales was not found” to the output character strings.

Next, the data analysis processing unit 110 analyzes correlations between records in which peculiar points exist (in this case, all records in the purchase data of the current month or records obtained by aggregating these records for sales) and the related data stored in the related data storage unit 140 similarly to step S122 of FIG. 7 (step S504).

On the other hand, if no peculiar point exists in the sales (step S502: NO), the data analysis processing unit 110 adds character strings indicating that there are no peculiar points, to the output character strings (step S505). This is because, in this case, no peculiar points were found by the scenario of the data analysis for each store.

Lastly, the data analysis processing unit 110 creates analysis result data similarly to step S123 of FIG. 7 (step S506).

[Data Analysis Process (Understanding of Overall Trend)]

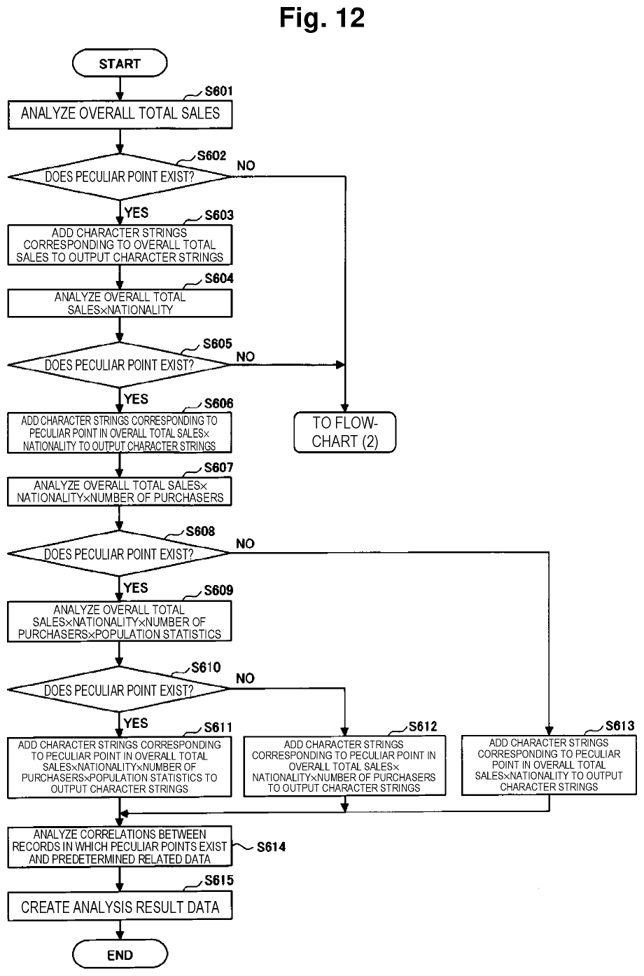

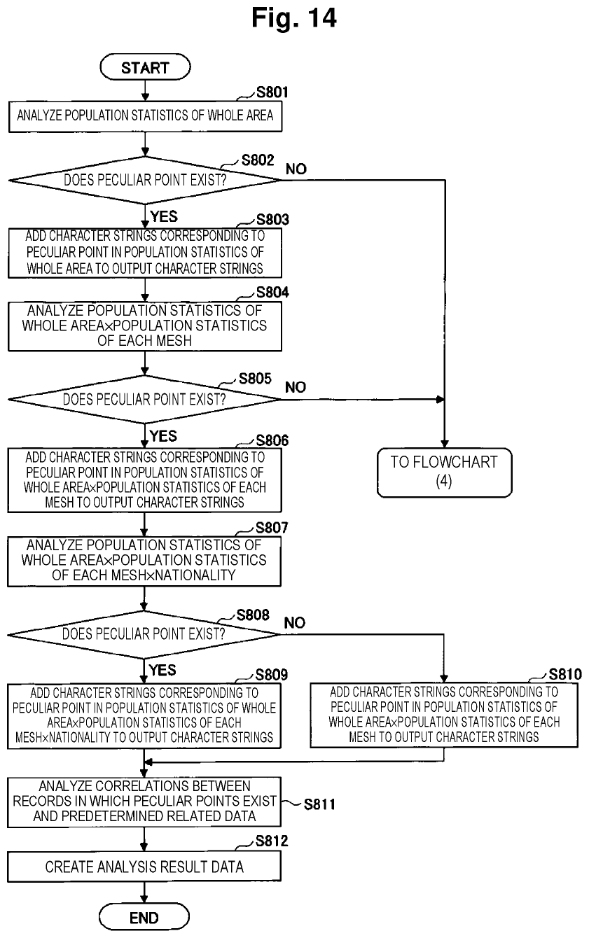

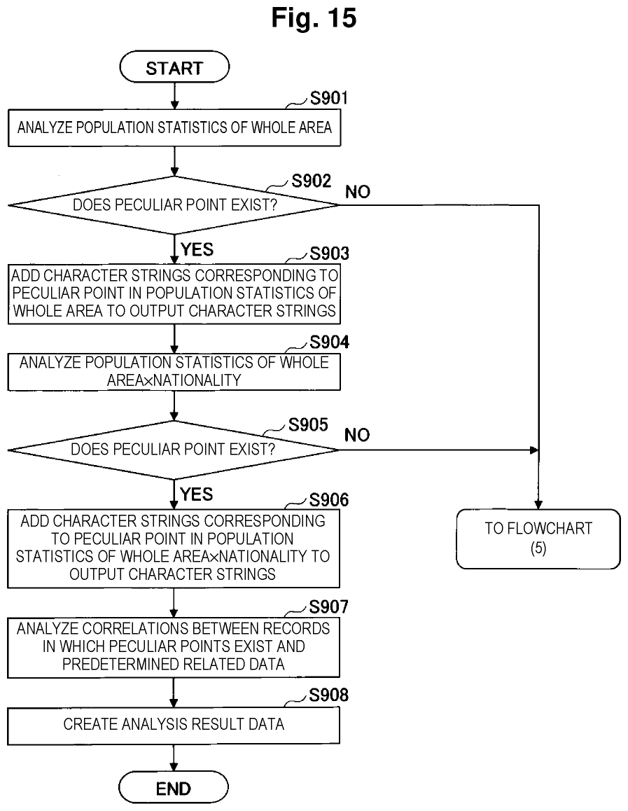

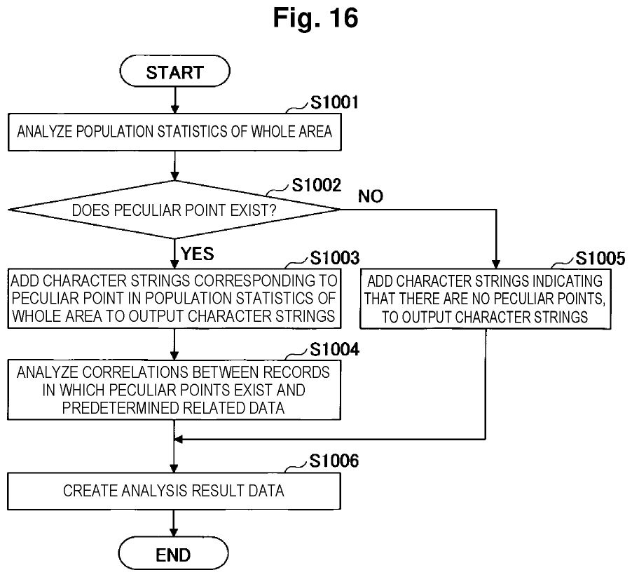

Hereinafter, a flow of a data analysis process for understanding of overall trend will be described with reference to FIGS. 12 to 16. FIGS. 12 to 16 are flowcharts (1) to (5) showing an example of the data analysis process for understanding of overall trend. Note that, as for these flowcharts (1) to (5), the flowcharts (1) to (4) correspond to the flows 1b to 4b shown in FIG. 6, respectively, and the flowchart (5) corresponds to the flowcharts 5b and 6b.

Further, hereinafter, it is assumed that the comparison target pair is “monthly all stores purchase data and all stores purchase data of the same month of the previous year”, and the monthly all stores purchase data includes “nationality”, “the number of purchasers” and “total purchase amount” are included as attributes similarly to FIG. 6. These pieces of all stores purchase data are stored in the purchase data storage unit 130. Note that the comparison target pair is set, for example, by the user.

(Flowchart (1))

First, the data analysis processing unit 110 analyzes whether or not a peculiar point exists in the overall total sales (that is, a total of all total purchase amounts of all the stores in the area in the current month) with “overall total sales” as an analysis target combination (step S601). For example, if there is a difference in the overall total sales equal to or above a predetermined threshold between the current month and the same month of the previous year, the data analysis processing unit 110 determines that a peculiar point exists in the overall total sales of all stores purchase data of the current month. Note that a ratio may be used instead of the difference (the same goes for the time of analyzing existence of a peculiar point hereinafter).

Then, if no peculiar point exists in the sales (step S602: NO), the data analysis processing unit 110 executes the flowchart (2). On the other hand, if a peculiar point exists in the sales (step S602: YES), the data analysis processing unit 110 adds character strings corresponding to the peculiar point of the overall total sales (for example, “Overall total sales are increasing against the same month of the previous year”, “Overall total sales are decreasing against the same month of the previous year” or the like) to output character strings (step S603). Note that, for example, which of “Overall total sales are increasing against the same month of the previous year” and “Overall total sales are decreasing against the same month of the previous year” is to be added to the output character strings is determined based on whether the overall total sales of the current month has been analyzed to be higher or lower in comparison with the overall total sales of the same month of the previous year as a result of the analysis of step S601 described above. The same goes for the time of adding predetermined character strings to the output character strings hereinafter.

Subsequent to step S603, the data analysis processing unit 110 analyzes whether a peculiar point exists in the overall total sales for each nationality, with “overall total sales” and “nationality” as an analysis target combination (step S604). For example, if such a nationality that there is a difference equal to or above a predetermined threshold in the overall total sales for each nationality between the current month and the same month of the previous year, the data analysis processing unit 110 determines that a peculiar point exists in the overall total sales for each nationality in the purchase data of the current month. Note that the overall total sales for each nationality refers to sales for each nationality in the total of all the total purchase amounts of all the stores in the whole area.

Then, if no peculiar point exists in the overall total sales for each nationality (step S605: NO), the data analysis processing unit 110 executes the flowchart (2). On the other hand, if a peculiar point exists in the overall total sales for each nationality (step S605: YES), the data analysis processing unit 110 adds character strings corresponding to the peculiar point of the overall total sales for each nationality (hereinafter, a nationality in which the peculiar point exists will be referred to as “a nationality A”) (for example, “And sales for the nationality A is increasing as a whole”, “And sales for the nationality A is decreasing as a whole”, or the like) to the output character strings (step S606).

Next, the data analysis processing unit 110 analyzes whether or not a peculiar point exists in the number of purchasers of the nationality A, with “overall total sales”, “nationality” and “the number of purchasers” as an analysis target combination (step S607). For example, if there is a difference in the number of purchasers of the nationality A equal to or above a predetermined threshold between the current month and the same month of the previous year, the data analysis processing unit 110 determines that a peculiar point exists in the number of purchasers of the nationality A in the all stores purchase data of the current month.

Then, if a peculiar point exists in the number of purchasers of the nationality A (step S608: YES), the data analysis processing unit 110 analyzes whether or not a peculiar point exists in the number of people of the nationality A in the whole area in the current month, from the number of people of the nationality A in the whole area in the current month and the number of people of the nationality A in the whole area in the same month of the previous year, with “nationality” and “the number of people” in the population statistics data stored in the related data storage unit 140 as an analysis target combination (step S609). For example, if there is a difference in the number of people of the nationality A in the whole area equal to or above a predetermined threshold between the current month and the same month of the previous year, the data analysis processing unit 110 determines that a peculiar point exists in the number of people of the nationality A in the whole area in the current month.

Then, if a peculiar point exists in the number of people of the nationality A in the whole area in the current month (step S610: YES), the data analysis processing unit 110 adds character strings corresponding to the peculiar point of the number of people of the nationality A in the whole area in the current month (for example, “The number of people of the nationality A is increasing in the whole area” or “The number of people of the nationality A is decreasing in the whole area”) to the output character strings (step S611).

On the other hand, if no peculiar point exists in the number of people of the nationality A in the whole area in the current month (step S610: NO), the data analysis processing unit 110 adds character strings corresponding to the peculiar point of the number of purchasers of the nationality A (for example, “The number of purchasers of the nationality A is increasing”, “The number of purchasers of the nationality A is decreasing”, or the like) to the output character strings (step S612).

Further, if a peculiar point exists in the number of purchasers of the nationality A (step S608: NO), the data analysis processing unit 110 adds character strings corresponding to the fact that there is a peculiar point in overall total sales for the nationality A, and there are no peculiar points in the number of purchasers of the nationality A (for example, “It is conceivable that the unit price has increased because the tendency of the number of purchasers of the nationality A has not changed”, “It is conceivable that the unit price has decreased because the tendency of the number of purchasers of the nationality A has not changed”, or the like) to the output character strings (step S613).

Subsequent to step S611, S612 or S613, the data analysis processing unit 110 analyzes correlations between records in which peculiar points exist (records in the all stores purchase data) and the related data stored in the related data storage unit 140 similarly to step S122 in FIG. 7 (step S614).

Lastly, the data analysis processing unit 110 creates analysis result data similarly to step S123 of FIG. 7 (step S615).

(Flowchart (2))

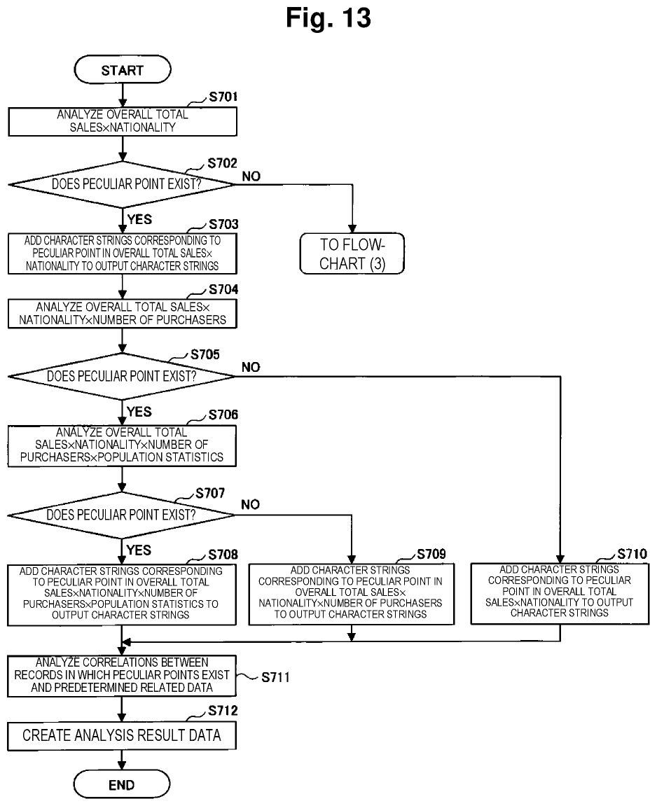

Steps S701 to S712 of FIG. 13 are similar to steps S604 to S615 of FIG. 12, respectively, except that the attribute “overall total sales” is not a peculiar point. In the flowchart (2), however, the data analysis processing unit 110 executes the flowchart (3) in the case of NO at step S702. Note that the case of the flowchart (2) being executed is, for example, a case where there are no peculiar points in the overall total sales in comparison with the same month of the previous year, but there is a difference in the overall total sales for each nationality.

(Flowchart (3))

First, the data analysis processing unit 110 analyzes whether or not a peculiar point exists in the number of people of the whole area in the current month, from the population (the number of people) of the whole area in the current month and the population (the number of people) of the whole area in the same month of the previous year, with “the number of people” in the population statistics data stored in the related data storage unit 140 as an analysis target combination (step S801). For example, if there is a difference in the number of people of the whole area equal to or above a predetermined threshold between the current month and the same month of the previous year, the data analysis processing unit 110 determines that a peculiar point exists in the number of people of the whole area in the current month.

Then, if a peculiar point exists in the number of people of the whole area in the current month (step S802: YES), the data analysis processing unit 110 adds character strings corresponding to the peculiar point of the number of people of the whole area in the current month (for example, “The number of people of the whole area is increasing against the same month of the previous year”, “The number of people of the whole area is decreasing against the same month of the previous year”, or the like) to output character strings (step S803).

On the other hand, if no peculiar point exists in the number of people of the whole area in the current month (step S802: NO), the data analysis processing unit 110 executes the flowchart (4).

Subsequent to step S803, the data analysis processing unit 110 analyzes whether or not a peculiar point exists in the number of people for each mesh in the area in the current month, from the population (the number of people) for each mesh in the area in the current month and the population (mesh) for each mesh in the area in the same month of the previous year, with “the number of people” and “mesh ID” in the population statistics data stored in the related data storage unit 140 as an analysis target combination (step S804). For example, if such a mesh that there is a difference equal to or above a predetermined threshold in the number of people for each mesh in the area between the current month and the same month of the previous year, the data analysis processing unit 110 determines that a peculiar point exists in the number of people for each mesh in the area in the current month. Hereinafter, when it is analyzed at this step that a peculiar point exists, a mesh in which the peculiar point exists will be referred to as “a mesh A”.

Then, if a peculiar point exists in the number of people for each mesh in the area in the current month (step S805: YES), the data analysis processing unit 110 adds character strings corresponding to the peculiar point of the number of people for each mesh (for example, “And the number of people of the mesh A is increasing”, “And the number of people of the mesh A is decreasing”, or the like) to the output character strings (step S806).

On the other hand, if no peculiar point exists in the number of people for each mesh in the area in the current month (step S805: NO), the data analysis processing unit 110 executes the flowchart (4).

Subsequent to step S806, the data analysis processing unit 110 analyzes whether or not a peculiar point exists in the number of people of each nationality in the mesh A in the area in the current month, from the population (the number of people) of each nationality in the mesh A in the area in the current month and the population (mesh) of each nationality in the mesh A in the area in the same month of the previous year, with “the number of people”, “mesh ID” and “nationality” as an analysis target combination (step S807). Hereinafter, when it is analyzed at this step that a peculiar point exists, a nationality in which the peculiar point exists will be referred to as “a nationality A”.

Then, if a peculiar point exists in the number of people of each nationality in the mesh A in the area in the current month (step S808: YES), the data analysis processing unit 110 adds character strings corresponding to the peculiar point of the number of people of each nationality in the mesh A (for example, “The number of people of the nationality A in the mesh A is increasing”, “The number of people of the nationality A in the mesh A is decreasing”, or the like) to the output character strings (step S809).

On the other hand, if no peculiar point exists in the number of people of each nationality in the mesh A in the area in the current month (step S808: NO), the data analysis processing unit 110 adds character strings corresponding to the fact that there is a peculiar point in the number of people of the mesh A, and there are no peculiar points in the number of people of each nationality (for example, “There are no remarkable changes in nationality”, or the like) to the output character strings (step S810).

Subsequent to step S809 or S810, the data analysis processing unit 110 analyzes correlations between records in which peculiar points exist (in this case records of the population statistics data) and the related data stored in the related data storage unit 140 similarly to step S122 of FIG. 7 (step S811).

Lastly, the data analysis processing unit 110 creates analysis result data similarly to step S123 of FIG. 7 (step S812).

(Flowchart (4))

First, the data analysis processing unit 110 analyzes whether or not a peculiar point exists in the number of people of the whole area in the current month, from the population (the number of people) of the whole area in the current month and the population (the number of people) of the whole area in the same month of the previous year, with “the number of people” in the population statistics data stored in the related data storage unit 140 as an analysis target combination (step S901).

Then, if a peculiar point exists in the number of people of the whole area in the current month (step S902: YES), the data analysis processing unit 110 adds character strings corresponding to the peculiar point of the number of people of the whole area in the current month (for example, “The number of people of the whole area is increasing against the same month of the previous year”, “The number of people of the whole area is decreasing against the same month of the previous year”, or the like) to output character strings (step S903).

On the other hand, if no peculiar point exists in the number of people of the whole area in the current month (step S902: NO), the data analysis processing unit 110 executes the flowchart (5).

Subsequent to step S903, the data analysis processing unit 110 analyzes whether or not a peculiar point exists in the number of people of each nationality in the area in the current month, from the population (the number of people) of each nationality in the area in the current month and the population (mesh) of each nationality in the area in the same month of the previous year, with “the number of people” and “nationality” in the population statistics data stored in the related data storage unit 140 as an analysis target combination (step S904). Hereinafter, when it is analyzed at this step that a peculiar point exists, a nationality in which the peculiar point exists will be referred to as “a nationality A”.

Then, if a peculiar point exists in the number of people of each nationality in the area in the current month (step S905: YES), the data analysis processing unit 110 adds character strings corresponding to the peculiar point of the number of people of each nationality (for example, “And the number of people of the nationality A is increasing”, “And the number of people of the nationality A is decreasing”, or the like) to the output character strings (step S906).

On the other hand, if no peculiar point exists in the number of people of each mesh in the area in the current month (step S905: NO), the data analysis processing unit 110 executes the flowchart (5).

Subsequent to step S806, the data analysis processing unit 110 analyzes correlations between records in which peculiar points exist (in this case, the records of the population statistics data) and the related data stored in the related data storage unit 140 similarly to step S122 of FIG. 7 (step S907).

Lastly, the data analysis processing unit 110 creates analysis result data similarly to step S123 of FIG. 7 (step S908).

(Flowchart (5))

The data analysis processing unit 110 analyzes whether or not a peculiar point exists in the number of people of the whole area in the current month, from the population (the number of people) of the whole area in the current month and the population (the number of people) of the whole area in the same month of the previous year, with “the number of people” in the population statistics data stored in the related data storage unit 140 as an analysis target combination (step S1001).

Then, if a peculiar point exists in the number of people of the whole area in the current month (step S1002: YES), the data analysis processing unit 110 adds character strings corresponding to the peculiar point of the number of people of the whole area in the current month (for example, “The number of people of the whole area is increasing against the same month of the previous year”, “The number of people of the whole area is decreasing against the same month of the previous year”, or the like) to output character strings (step S1003).

Next, the data analysis processing unit 110 analyzes correlations between records in which peculiar points exist (in this case, the records of the population statistics data) and the related data stored in the related data storage unit 140 similarly to step S122 of FIG. 7 (step S1004).

On the other hand, if no peculiar point exists in the number of people of the whole area in the current month (step S1002: NO), the data analysis processing unit 110 adds character strings indicating that there are no peculiar points, to the output character strings (step S1005). This is because, in this case, no peculiar points were found by the scenario of the data analysis for understanding of overall trend.

Lastly, the data analysis processing unit 110 creates analysis result data similarly to step S123 of FIG. 7 (step S1006).

[Analysis Result Report]

Next, the analysis result report displayed on the report display terminal 30 by the report display processing unit 120 will be described. The analysis result report is created by the report display processing unit 120 based on analysis result reports stored in the analysis result data storage unit 150 and transmitted to the report display terminal 30. Hereinafter, an analysis result report for each store, an analysis result report for understanding of overall trend and an analysis result report for correlation analysis will be described as examples.

(Analysis Result Report (for Each Store))

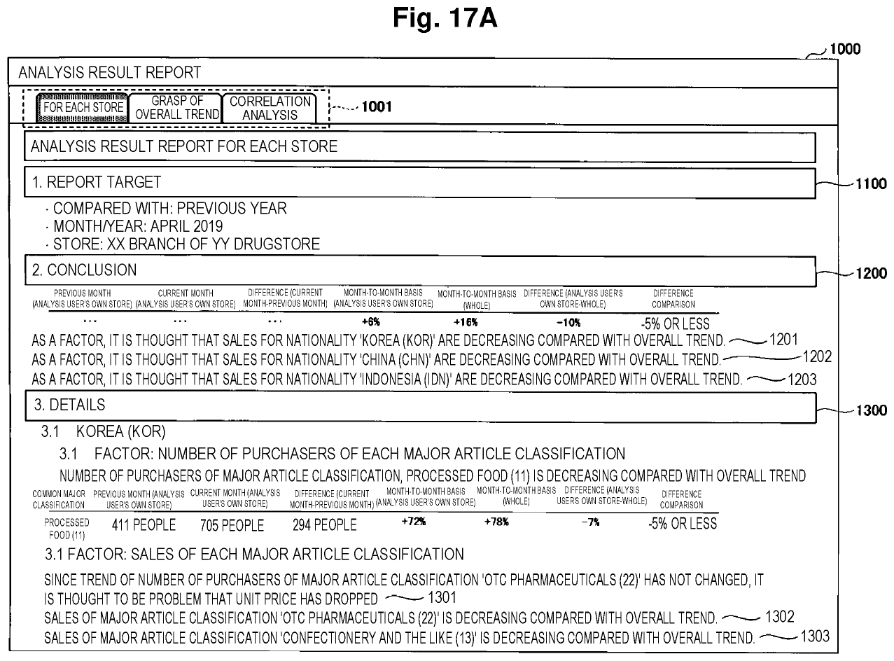

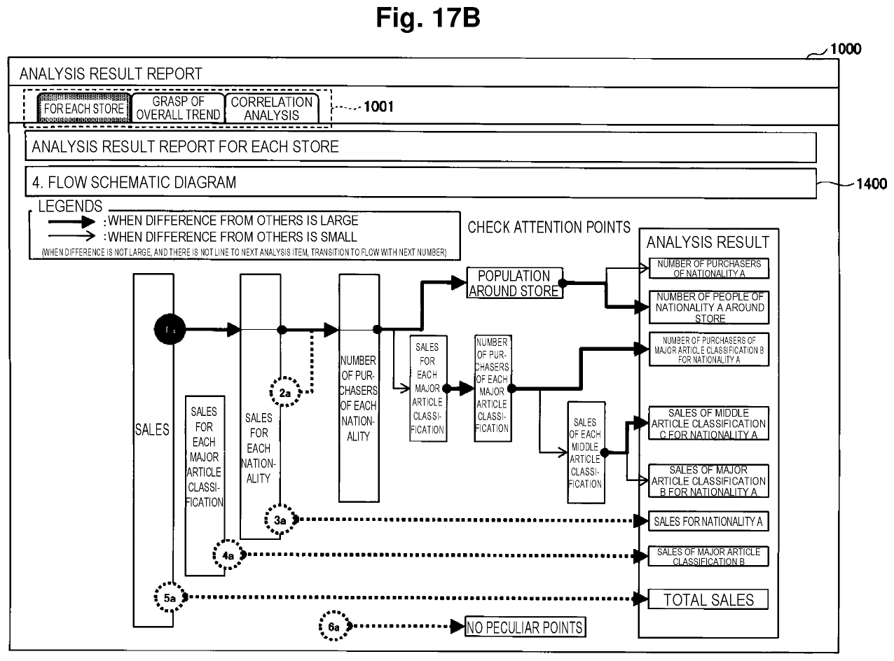

An analysis result report 1000 for each store is shown in FIGS. 17A and 17B. The analysis result reports 1000 shown in FIGS. 17A and 17B are, for example, a screen of the first page and a screen of the second page of the analysis result report 1000, respectively.

The analysis result report 1000 includes, for example, “1. Report target” field 1100, “2. Conclusion” field 1200, “3. Details” field 1300 and “4. Flow schematic diagram” field 1400. In “1. Report target” field 1100, information for identifying a comparison target pair that includes analysis target data (for example, purchase data) is displayed. In “2. Conclusion” field 1200, a result of data analysis (for example, an analysis result of sales) is displayed. Here, in “2. Conclusion” field 1200, output character strings 1201 to 1203, and the like are displayed. These output character strings 1201 to 1203, and the like are character strings corresponding to peculiar points and indicate causes (factors) of relevant attributes having become the peculiar points. By defining data analysis flows in advance as a scenario, these output character strings can also be defined in advance according to peculiar points in analyses in the flows. Since it is possible for the user to know a reason for a data analysis result by referring to these output character strings 1201 to 1203, and the like, it becomes possible for him to easily perform interpretation of the data analysis result and perform effective solution of business problems.

In “3. Details” field 1300, detailed information about the data analysis result displayed in “2. Conclusion” field 1200 is displayed. In “3. Details” field 1300, for example, a data analysis result of a comparison target pair in which it has been analyzed that a peculiar point exists, and output character strings 1301 and 1302, and the like of the data analysis result are displayed. By referring to these output character strings 1301 and 1302, and the like, it becomes possible for the user to perform effective solution of business problems as described above.

Furthermore, in “4. Flow schematic diagram” field 1400, a flow in which data analysis was performed is visualized and displayed. In the example shown in FIG. 17B, it is displayed that data analysis was performed according to the flow 1a. By referring to this flow schematic diagram, the user can know what kind of data analysis was performed.

Note that the analysis result report 1000 also includes a display switching tab 1001, and it is possible to mutually switch display among the analysis result report for each store, the analysis result report for understanding of overall trend and the analysis result report for correlation analysis.

(Analysis Result Report (Understanding of Overall Trend))

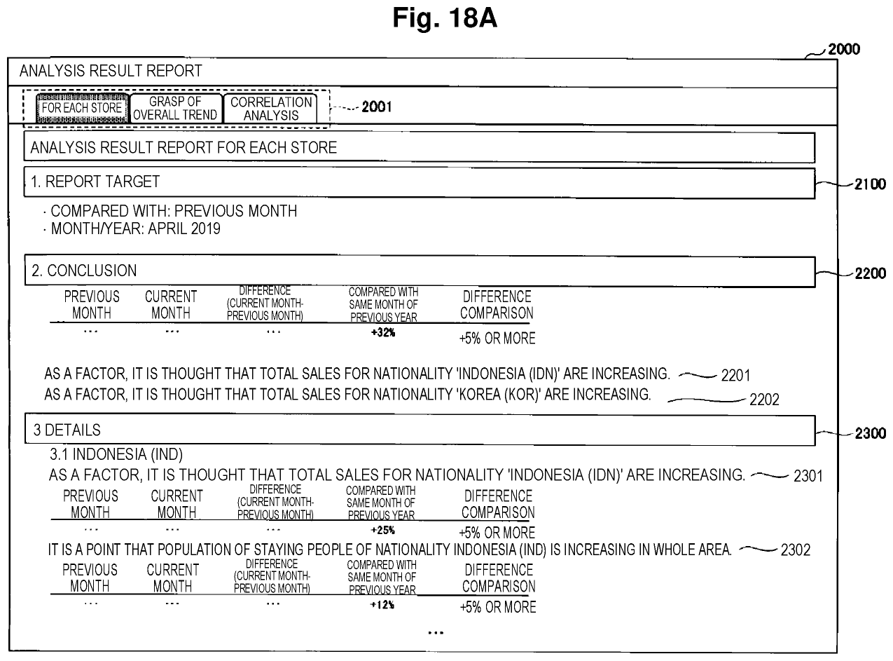

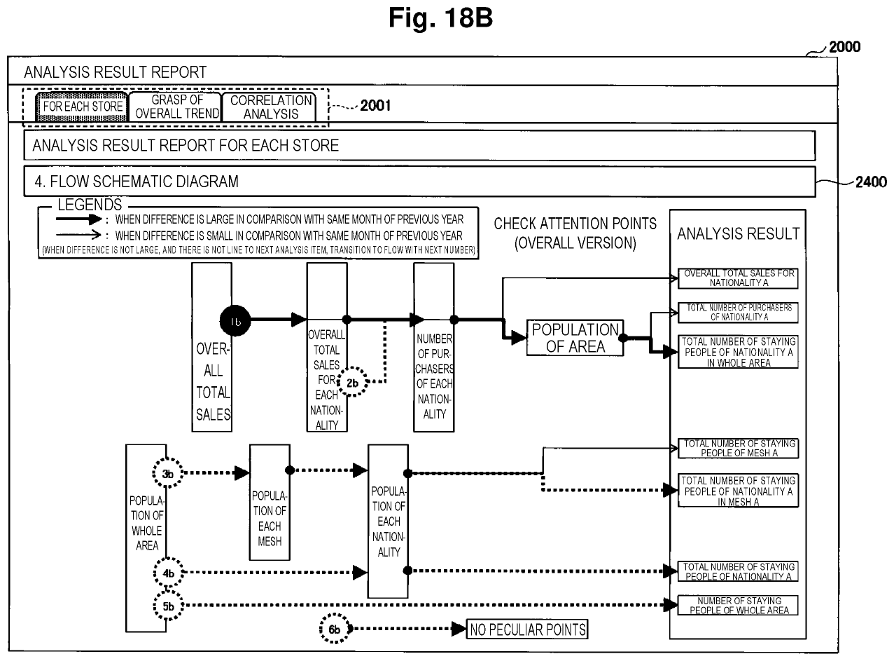

An analysis result report for understanding of overall trend 2000 is shown in FIGS. 18A and 18B. The analysis result reports 2000 shown in FIGS. 18A and 18B are, for example, a screen of the first page and a screen of the second page of the analysis result report 2000, respectively.

The analysis result report 2000 includes, for example, “1. Report target” field 2100, “2. Conclusion” field 2200, “3. Details” field 2300 and “4. Flow schematic diagram” field 2400. In “1. Report target” field 2100, information for identifying a comparison target pair that includes analysis target data (for example, all stores purchase data) is displayed. In “2. Conclusion” field 2200, a result of data analysis (for example, an analysis result of sales) is displayed. Here, in “2. Conclusion” field 2200, output character strings 2201 and 2202, and the like are displayed. These output character strings 2201 and 2202, and the like are character strings corresponding to peculiar points. Since it is possible for the user to know a reason for a data analysis result by referring to these output character strings 2201 and 2202, and the like, it becomes possible for him to easily perform interpretation of the data analysis result and perform effective solution of business problems.

In “3. Details” field 2300, detailed information about the data analysis result displayed in “2. Conclusion” field 2200 is displayed. In “3. Details” field 2300, for example, a data analysis result of a comparison target pair in which it has been analyzed that a peculiar point exists, and output character strings 2301 and 2302, and the like of the data analysis result are displayed. By referring to these output character strings 2301 and 2302, and the like, it becomes possible for the user to perform effective solution of business problems as described above.

Furthermore, in “4. Flow schematic diagram” field 2400, a flow in which data analysis was performed is visualized and displayed. In the example shown in FIG. 17B, it is displayed that data analysis was performed according to the flow 1b. By referring to this flow schematic diagram, the user can know what kind of data analysis was performed.

Note that the analysis result report 2000 also includes a display switching tab 2001, and it is possible to mutually switch display among the analysis result report for each store, the analysis result report for understanding of overall trend and the analysis result report for correlation analysis.

(Analysis Result Report (Correlation Analysis))

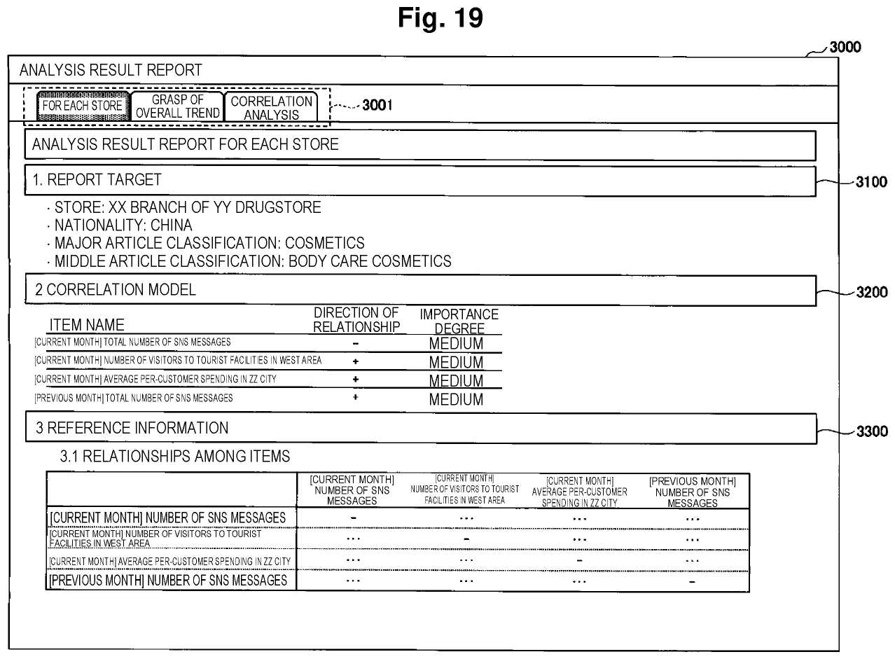

An analysis result report 3000 for correlation analysis is shown in FIG. 19. The analysis result report 300 includes, for example, “1. Report target” field 3100, “2. Correlation model” field 3200 and “3. Reference information” field 4300. In “1. Report target” field 3100, analysis target data, and information for identifying attributes targeted by analysis (that is, attributes in which it has been analyzed that peculiar points exist) are displayed. In “2. Correlation model” field 3200, a correlation direction between the analysis target data and related data (that is, which of a positive correlation and a negative correlation exists) and importance thereof are displayed. Note that the importance is determined, for example, by the magnitude of the absolute value of a correlation coefficient. In “3. Reference information” field 4300, values of correlation coefficients between the analysis target data and the related data are displayed in a matrix format. By referring to a correlation analysis result, the user can know elements (for example, events, incidents, matters and the like) related to the peculiar points and it becomes possible for him to perform effective solution of business problems.

Note that the analysis result report 3000 also includes a display switching tab 3001, and it is possible to mutually switch display among the analysis result report for each store, the analysis result report for understanding of overall trend and the analysis result report for correlation analysis.

The present invention is not limited to the above embodiment specifically disclosed, but various kinds of modifications and changes are possible without departing from Claims.

### REFERENCE SIGNS LIST

1 Data analysis system
10 Data analysis device
20 Store terminal
30 Report display terminal
40 Population statistics management server
110 Data analysis processing unit
120 Report display processing unit
130 Purchase data storage unit
140 Related data storage unit
150 Analysis result data storage unit

1. An analysis device for analyzing data including a plurality of attributes, the analysis device comprising:
a memory;
a processor configured to
analyze whether, according to a flow defined as a scenario in advance, between analysis target data and comparison target data, the analysis target data takes a peculiar value in comparison with the comparison target data for a combination of one or more attributes defined for the flow in analysis order defined for the flow; and
cause second analysis means for, in response to an analysis of the peculiar value being taken, according to an attribute analyzed to take the peculiar value, a name of the attribute and character strings indicating a cause of occurrence of the peculiar value in the attribute to be character strings included in a report in which results of the analyses are displayed; wherein
the character strings are character strings defined in advance for each of the analyses in the analysis order defined for the flow.

2. The analysis device according to claim 1, wherein
in the scenario, a plurality of flows are defined so that flow priority is higher as the number of the combined one or more attributes is larger, and, in each of the flows, the analysis order of combinations of the one or more attributes is defined so that data analysis granularity is gradually finer; and
according to the flows in descending order of the priority, the processor analyzes whether or not the analysis target data takes a peculiar value in comparison with the comparison target data for the combinations of the one or more attributes defined for each of the flows in analysis order defined for the flow.

3. The analysis device according to claim 2, wherein
in the scenario, the flows are defined so that the priority is higher in order of a first flow for performing the analysis for a combination of a first attribute indicating information related to sales, a second attribute indicating a target to purchase an article and a third attribute indicating information about the article, a second flow for performing the analysis for a combination of the first attribute and the second attribute, a third flow for performing the analysis for a combination of the first attribute and the third attribute and a fourth flow for performing the analysis for the first attribute.

4. The analysis device according to claim 1, comprising
display for causing the report in which the analysis results and the character strings caused to be included into the report are associated to be displayed on a display device connected to the analysis device.

5. The analysis device according to claim 4, wherein
the report further includes a flowchart indicating which flow, of the one or more flows defined as the scenario in advance, the analyses have been performed according to.

6. An analysis system for analyzing data including a plurality of attributes, the analysis system comprising:
a memory;
a processor configured to
analyze whether, according to a flow defined as a scenario in advance, between analysis target data and comparison target data, the analysis target data takes a peculiar value in comparison with the comparison target data for a combination of one or more attributes defined for the flow in analysis order defined for the flow; and
cause in response to an analysis of the peculiar value being taken, according to an attribute analyzed to take the peculiar value, a name of the attribute and character strings indicating a cause of occurrence of the peculiar value in the attribute to be character strings included in a report in which results of the analyses are displayed; wherein
the character strings are character strings defined in advance for each of the analyses in the analysis order defined for the flow.

7. An analysis method, wherein a computer analyzing data including a plurality of attributes executes:
a first analysis procedure for, according to a flow defined as a scenario in advance, analyzing whether, between analysis target data and comparison target data, the analysis target data takes a peculiar value in comparison with the comparison target data for a combination of one or more attributes defined for the flow in analysis order defined for the flow; and
a second analysis procedure for, in response to an analysis of the peculiar value being taken, causing, according to an attribute analyzed to take the peculiar value, a name of the attribute and character strings indicating a cause of occurrence of the peculiar value in the attribute to be character strings included in a report in which results of the analyses are displayed; wherein
the character strings are character strings defined in advance for each of the analyses in the analysis order defined for the flow.

8. (canceled)
